(19) United States
(12) Patent Application Publication
(10) Pub. No.: US 2012/0230887 A1
(43) Pub. Date: Sep. 13, 2012

(54) DEVICES AND METHODS FOR INTERFACING MICROFLUIDIC DEVICES WITH MACROFLUIDIC DEVICES

(75) Inventor: Piero Zucchelli, Versonnex (FR)

(73) Assignee: SPINX, INC., Geneva (CH)

(21) Appl. No.: 13/480,011

(22) Filed: May 24, 2012

Related U.S. Application Data
(63) Continuation of application No. 13/264,459, now abandoned.
(60) Provisional application No. 61/169,838, filed on Apr. 16, 2009.
(60) Provisional application No. 61/177,694, filed on May 13, 2009.

(51) Int. Cl. B01L 3/00

(52) U.S. Cl. 422/502

(57) ABSTRACT

The present disclosure is directed generally to devices and methods with the purpose of interfacing microfluidic devices with macrofluidic devices. Specifically, the present disclosure includes the de- [symbol] 102 sign of a fluidic tile in such a way that macrofluidic structures and/or microfluidic structures may be placed in fluid communication with each other such that assays, reactions, processes, or procedures may be carried out within the tile with the same reagent, sample, biological sample, or fluid volumes as known in the art for performing such assays, reactions, processes, or procedures.

### CROSS REFERENCE TO RELATED APPLICATIONS

This application is a continuation of U.S. patent application Ser. No. 13/264,459, filed on Oct. 14, 2011, which is a 371 of International Application No. PCT/US2010/031411 and claims the benefit of U.S. Provisional Patent Application Ser. No. 61/169,838, filed on Apr. 16, 2009 and U.S. Provisional Patent Application Ser. No. 61/177,694, filed on May 13, 2009, the contents of which are incorporated herein by reference in their entirety.

### FIELD OF THE DISCLOSURE

The present disclosure relates to the field of microfluidic circuits for chemical, biological, and biochemical processes or reactions. More specifically, it discloses devices and methods for interfacing microfluidic devices with macrofluidic devices.

### BACKGROUND OF THE DISCLOSURE

In recent years, the pharmaceutical, biotechnology, chemical and related industries have increasingly adopted devices containing micro-chambers and channel structures for performing various reactions and analyses. These devices, commonly referred to as microfluidic devices, allow a reduction in volume of the reagents and sample required to perform an assay. They also enable a large number of reactions without human intervention, either in parallel or in serially, in a very predictable and reproducible way. Microfluidic devices are therefore promising devices to realize a Micro Total Analysis System (micro-TAS), definition that characterizes miniaturized devices that have the functionality of a conventional laboratory.

In general, all attempts at micro-TAS devices can be characterized in two ways: according to the forces responsible for the fluid transport and according to the mechanism used to direct the flow of fluids. The former are referred to as motors. The latter are referred to as valves, and constitute logic or analogue actuators, essential for a number of basic operations such as volumetric quantitation of fluids, mixing of fluids, connecting a set of fluid inlets to a set of fluid outputs, sealing containers (to gas or to liquids passage according to the application) in a sufficiently tight manner to allow fluid storage, and regulating the fluid flow speed. A combination of valves and motors on a microfluidic network, complemented by input means to load the devices, and readout means to measure the outcome of the analysis, make a micro-TAS possible and useful.

Fluid handling devices, also called fluid handlers, dispensing devices, sample loading robots, compound dispensers, dispensing means, pipettors, and pipette workstations, have the purpose of transferring fluids, and in particular liquids, from fluid storage to further fluid storage. The components that take part in a typical fluid handling process can therefore be classified into three categories, according to their role in the process: (i) the source of the original fluid storage, (ii) the means by which the fluid is transferred, and (iii) the container in the fluid storage where the fluid is moved to.

In general terms, an automated dispensing device is not always strictly needed, since the dispensing operation could be performed by a human operator equipped with specific tools, like pipettors or similar devices. However, all dispensing devices can be described according to their overall characteristics, like for example operational speed, performance, cost, contamination issues and versatility. The desired requirements of fluid handling devices are the highest speed possible (to achieve high productivity, but also to allow to perform assays in similar conditions like temperature, reagents activity, etc), minimal contamination between sources and containers, minimal fixed cost and minimal cost per dispensing operation (consumables), performances (precision of dosing, range of volumes that can be dispensed, footprint, etc.) and versatility (multi-format compatibility, type of operations performed, automatic identification of source and container, etc.).

All existing fluid handling devices address or partially solve these requirements, and the user choice depends on the specific application and on the laboratory environment. Being the environments heterogeneous, the dispensing instruments—exactly as it is for the fluid storage means—differ significantly and adopt different technologies: disposable tips and suction means, metallic pins immerged in the fluids, aspirating needles and subsequent rinsing and cleaning operations, pumps and tubing, ejection of droplets by piezoelectric or other mechanical means. Also the infrastructure surrounding the dispensing technology and its degree of automation differ enormously, going from complex installations for compound libraries management in the pharmaceutical industry, to simple hand-held devices.

Centripetal devices are a specific class of microfluidic devices, where the micro-fluidic devices are spun around a rotation axis in such a way that the centripetal acceleration generates an apparent centrifugal force on the microfluidic device itself, and on any fluid contained within the microfluidic device. The centrifugal force acts as a motor, in the radial but also in the tangential direction if the angular momentum varies. This force, however, is applied at the same time to any material contained in the microfluidic device, including the fluids that are contained in the inlets. In most centripetal microfluidic devices, like for example those developed by Gyros AB, Tecan AG, Burstein Technologies Inc. for example, micro-fluidic devices have the shape of disks, and the rotation axis is perpendicular to the main faces and passing through the centre of the disk.

### SUMMARY OF THE DISCLOSURE

The present disclosure is directed towards a fluidic tile in which fluid flow is regulated by putting a microfluidic component and a macrofluidic component that are initially separated into fluid communication. Both the time at which the two components are connected and the position of such fluid communication are arbitrary and can be determined externally. Accordingly, the disclosure describes an infinite number of virtual valves, all of which are initially in the closed state, but may be opened at any time, at multiple locations that do no need to be predetermined and in any order.

When a virtual valve according to the disclosure is closed, a fluid, gas or solid and mixtures thereof may be contained in a first macrofluidic component. As soon as the virtual valve is opened, communication is enabled to at least one or more additional microfluidic or macrofluidic components through at least one microfluidic component. Whether the fluid, gas or solid and mixtures thereof will flow into the additional components, to what extent and at which speed, depends on the forces acting on the fluid gas or solid and mixtures thereof and the impediments to flow through valving components.

In microfluidic circuits, fluid transport may be achieved through the use of mechanical micropumps, electric fields, application of acoustic energy, external pressure, or centripetal force. A valve according the disclosure is independent of the mechanism for fluid transport and is therefore compatible with, but not limited to, any of the above means for fluid transport.

Accordingly, in one aspect of the present disclosure, an apparatus for processing biological or chemical fluids includes a microfluidic substrate comprising a plurality of microfluidic components or structures and a macrofluidic substrate comprising a plurality of macrofluidic components or structures corresponding to the microfluidic components or structures. It is contemplated within the scope of the disclosure that the inventive apparatus may further comprise additional substrate layers. According to the disclosure, these additional substrate layers can contain a plurality of fluidic channels, chambers and manipulative components or structures such as lenses and filters.

Between each substrate layer, a material layer or perforation layer may separate the plurality of microfluidic components or structures from the plurality of macrofluidic components or structures or additional components or structures. The structure of the material layer could be homogeneous or heterogeneous, for example including multilayer and coatings. According to the disclosure the material layer or perforation layer may be comprised of a polymeric compound such as Poly(rnethyl methacrylate), hereafter referred to as PMMA, or other material such as Low Density Polyethylene (LDPE), Linear Low Density Polyethylene (LLDPE), High Density Polyethylene HDPE), Polyethylene Teraphathalate (PET), Polyethylene (PE), polycarbonate (PC), Polyethylene Terephthalate Glycol (PETG), Polystyrene (PS), Ethyl Vinyl Acetate (EVA), polyethylene napthalate (PEN), Cyclic Olefin Homopolymers (COP), Cyclic Olefin Copolymers (COC), or the like. These polymers can be used singularly or in combination with each other. The use of polymers is preferred because of its ease of use and manufacturing. It is clear that other options, for example metallic foils with or without additional surface treatment, are possible.

The material layer may further comprise optical dye or other like material or layers having adsorptive properties of pre-selected electromagnetic radiation. The absorption can occur through known modifications as those used in absorbing light filters, for example including metallic foils or modifying the surface optical characteristics (n refraction index and k extinction coefficient) or by means of other surface properties like roughness, in such a way that a sufficient amount of pre-selected electromagnetic energy is absorbed with the consequence of perforation. Other technologies can make use of light absorbing globules, for example carbon-black particles, dye emulsions, suspensions or nanocrystals. In addition, reflective layers, polarization changing layers, wavelength shifting layers could be used to enhance the effective absorption of electromagnetic energy.

An advantage of the current disclosure consists in the extreme compactness and flexibility of the virtual valve in a microfluidic circuit that allows maximizing the surface used for fluid storage, incubation and reactions to occur. The virtual valve size, by tuning the optical system position, power and pulse duration of the electromagnetic radiation generating means, can be also adapted to the circuit in a wide range of dimensions, down to the diffraction limit or below. When laminar flow is desired within the microfluidic circuit, the virtual valve cross section should approximately match the cross section of the capillaries that are interconnected.

In another aspect of the present disclosure, an apparatus or fluidic tile for performing reactions, assays, processes, or procedures in accordance with the same sample, reagent, biological sample, or fluid volumes known in the art. The apparatus may include a microfluidic substrate comprising at least one microfluidic structure, a macrofluidic substrate comprising at least one macrofluidic structure corresponding to the microfluidic structures in the microfluidic substrate, and a layer of material or film positioned between the microfluidic substrate and the macrofluidic substrate forming an interface between each of the microfluidic structures and macrofluidic structures. The apparatus may further include an electromagnetic radiation generating means for generating electromagnetic radiation for directing onto the material layer. The electromagnetic generating means may allow for perforation of the material or film layer at the interface of the microfluidic structures and macrofluidic structures allowing the microfluidic structures and or macrofluidic structures to be placed in fluid communication without damage or substantial alteration to the biological sample or fluids within the fluidic tile. This addresses the need of a flexible, programmable fluid handling device interfacing microfluidics with macrofluidics. The choice of the fluids involved in a reaction, for example, can be made in real time during protocol execution.

The functionality of a specific microfluidic structure or circuit and/or a specific macrofluidic structure can be configured within the fluidic tile to perform desired assays, reactions, or procedures upon a selected sample or biological sample. It is contemplated within the scope of the disclosure that any microfluidic, macrofluidic, or fluidic assay, reaction, or procedure known in the art can be configured within the tile to achieve a desired functionality. For example, it is contemplated that one or more of the steps and processes necessary to process nucleic acids or biological samples, using the same volumes known in the art, may be incorporated into the tile, such as DNA extraction, DNA purification, DNA shearing, sonication, DNA end-repair, polymerase chain reactions (PCR), quantitative polymerase chain reactions (qPCR), ligation and enzymatic reactions on PCR. It should be understood that these processes are not limited to homogeneous phase, and could include beads manipulation, filtering, gel electrophoresis, capillary electrophoresis, nick-translation, exposure of the samples to coated surfaces (ELISA), exposure of the liquids to patterned surfaces (like arrays and similar).

For example, the macrofluidic substrate may include chambers which may contain reagents, samples, biological samples, and the like for performing a desired process. The chambers in the macrofluidic substrate may include but are not limited to at least one purification chamber which may contain, but is not limited to silica beads, fits, coated beads, ion exchange resins, and monoliths, and the like; holding chambers; mixing chambers; sonication chambers; fractionation chambers; reaction chambers; gel electrophoresis chambers; PCR reaction chambers, and DNA quantitation chambers. The chambers within the macrofluidic substrate may correspond to microfluidic structures in the microfluidic substrate such that the chambers within the macrofluidic substrate may be placed in fluid communication with additional chambers in the macrofluidic substrate and/or microfluidic substrate.

In another aspect of the present disclosure, the chambers within the fluidic tile may be pre-loaded and may be sealed with a sample, reagent, biological sample or the like therein. The purpose of pre-loading the tile may allow for a user to simply add the sample, reagent, biological sample or the like the user may want to process within the tile. This may allow for automated processing of samples, reagents, biological samples or the like within the tile. In one example the macrofluidic substrate may be pre-loaded with any sample, reagent, biological sample or the like known in the art such as but not limited to electrophoresis gel, purification column components (for example silica beads), any buffers known in the art, a PCR mix, primers, enzymes, adaptors, dNTP, and DNA ladders.

Some advantages of performing biological and chemical operations are shown in the following description by the example of the preparation of a nucleic acid library for sequencing. It should be understood that the application of the methods and apparatus involved is not limited to this process, which is representative, in its components and principles, of various biological, biochemical, or chemical applications like molecular diagnostics testing, purification and extraction of genetic material from tumours or primary tissues or fluids, viral load tests performed on body fluids or tissues, bacterial detection or quantitation in biological samples and other materials like food or water, environmental monitoring of contaminations, detection of forensic evidences for legal purposes, agricultural monitoring of parasites and the likes, determination of the age of a living entity.

Processing a nucleic acid fragment library within an embodiment of the fluidic tile according to the disclosure may result in more efficient processing. Currently, preparation of a nucleic acid fragment library requires multiple steps to be performed individually by the preparer, such as preparing and transferring liquids from one container to another, reacting, mixing, purifying, incubating, and the like with multiple different devices. Through the use of one embodiment of the present disclosure a preparer may only have to add the sample for which a nucleic acid fragment library is to be prepared, and all of the additional steps may be performed within the tile. Thus, embodiments of the present disclosure may increase the efficiency of performing a desired process or procedure, eliminate the possibility of human error within the process or procedure, minimize the possibility of external agents contaminating the sample, minimize the possibility of contaminating the environment, and allow for accurate repeatable measurements to be taken of samples within the tile.

Further, the tile may have input ports and output ports which may be sealed by the use of a film layer. The use of film layer covering the input and output ports is done routinely in drugs discovery when using standard micro-plates between the operation of loading reagents and the actual assay. The film layer prevents contamination and minute quantities of fluid from evaporating, with the consequence of changing their concentration and therefore modifying the assay or process conditions.

The sealing film can be a layer of polymer, metal or a combination of both. The film can be applied by means of additional pressure sensitive or heat sensitive adhesives, but also the film itself could present intrinsic adhesive properties. Further, the film may be the same perforable film layer that may be placed between the microfluidic and microfluidic substrates of the tile. Heat sealing is one of the options most compatible with reagents, and it is used both for temporary sealing (peelable films that prevent evaporation) or permanent sealing (long term storage that guarantees the integrity of the sample, like in drugs packages). Other embodiments of sealing options comprise the use of films that can be pierced by needles or tips, allowing the passage of fluids during dispensing but preventing the passage of gas after the fluid dispensing has been performed.

Further, the liquid contained in the sealed reservoir or chambers can be transferred into the microfluidic or macrofluidic structures without requiring the opening of the seal. Therefore an individual tile, pre-loaded with reagents, can be processed directly without requiring the opening of the sealed reservoirs that could be therefore permanently sealed. In fact, the reservoir or chamber can be put in fluidic communication with microfluidic or macrofluidic structures within the tile by the opening of two lines, one required for the liquid flow and the second one required for the passage of gas, typically air, to prevent the formation of an under pressure in the reservoir that would prevent the extraction of the liquid. With this method, tile pre-loading becomes possible and can also be applied to a subset of the inputs present in the tile.

In another aspect of the present disclosure, the tile may have a plurality of input and or output ports. The number of input and output ports per tile, the number of tiles, and the orientation of the tiles can be changed to achieve various configurations having a standard laboratory format or a custom format, for example the input and/or output ports may correspond to a standard parallel dispenser. The various configurations are dependent on the tile design and on the application and strategy to input or collect samples, reagents, biological samples, and the like. The number of input ports and output ports on the tile can be made without requiring changes to the fluid handling device.

These and other advantages, objects, and features of the disclosure will be apparent through the detailed description of the embodiments and the drawings attached hereto. It is also to be understood that both the foregoing general description and the following detailed description are exemplary and not restrictive of the scope of the disclosure.

### BRIEF DESCRIPTION OF THE DRAWINGS

These and other advantages, objects and features of the disclosure will be apparent through the detailed description of the embodiments and the drawings attached hereto. It is also to be understood that both the foregoing general description and the following detailed description are exemplary and not restrictive of the scope of the disclosure.

FIG. 1 illustrates an embodiment of the components of a fluidic tile;

FIG. 2 illustrates another embodiment of the fluidic tile;

FIG. 3 illustrates an embodiment of a process of metering specific volumes within the fluidic tile;

FIG. 3A illustrates a cross-sectional view of another embodiment of a process of metering specific volumes within the fluidic tile;

FIG. 4 illustrates an embodiment of a process of filling chambers serially within the fluidic tile;

FIG. 5 illustrates an embodiment of a process of washing a chamber within the fluidic tile;

FIG. 6 illustrates an embodiment of a process of purging/eluting a fluid from a chamber within the fluidic tile;

FIG. 7 illustrates a top view of another embodiment of the fluidic tile;

FIG. 7A illustrates an embodiment of a sonication chamber within the fluidic tile;

FIG. 7B illustrates an embodiment of a purification chamber within the fluidic tile;

FIG. 7C illustrates an embodiment of a gel electrophoresis chamber within the fluidic tile;

FIG. 7D illustrates another embodiment of a gel electrophoresis chamber within the fluidic tile;

FIG. 7E illustrates an embodiment of PCR chambers within the fluidic tile;

FIG. 8 illustrates an embodiment of a process for preparing a nucleic acid fragment library within the fluidic tile;

FIG. 9 illustrates an embodiment of a process for performing quantitation with the fluidic tile;

FIG. 10 illustrates an embodiment of the fluidic tile having sealed input and output ports;

FIG. 11 illustrates an embodiment of process for inputting and extracting fluids from the fluidic tile having sealed input and output ports; and

FIG. 12 illustrates an embodiment of a process for filling a plurality of input ports using a parallel dispenser.

### DETAILED DESCRIPTION OF THE DISCLOSURE

The present disclosure provides fluidic tiles that may be used within centripetal systems, such as but not limited to centrifugal rotors, and microfluidic platforms as well as a number of its applications for providing centripetally-motivated fluid micromanipulation and macromanipulation. For the purpose of illustration, the drawings as well as the description will generally refer to centripetal systems. However, the means disclosed in this disclosure are equally applicable in microfluidic and macrofluidic components relying on other forces to effect fluid transport.

For the purpose of this specification no distinction should be made between inputs, inlets,outlets, ports, connections, wells, reservoirs and similar words, all referring to the means by which fluids can enter, or exit, from the fluidic network.

For the purposes of this specification, the term “sample” will be understood to encompass any fluid, reagent, solution or mixture, either isolated or detected as a constituent of a more complex mixture, or synthesized from precursor species.

For the purposes of this specification, the term “in fluid communication” or “fluidly connected” is intended to define components that are operably interconnected to allow fluid flow between components. In illustrative embodiments, the analytical platform comprises fluidic tiles within a rotatable platform, such as micro-fluidic tiles, whereby fluid movement on the tile is motivated by centripetal force upon rotation of the tile and fluid movement on the tile is motivated by pumps.

For the purposes of this specification, the term “biological sample”, “sample of interest” or “biological fluid sample” will be understood to mean any biologically-derived analytical sample, including but not limited to DNA, blood, plasma, serum, lymph, saliva, tears, cerebrospinal fluid, urine, sweat, plant and vegetable extracts, semen, water, food or any cellular or cellular components of such sample.

For the purposes of this specification, the term “meso-scale”, or “nano-scale” will be 10 understood to mean any volume, able to contain as fluids, with dimensions preferably in the sub-micron to millimetre range.

Representative applications of fluidic tiles within a centripetal system (e.g., centrifuge) employ rectangular shaped devices, with the rotation axis positioned outside the device's footprint. For the purpose of illustration, the drawings, as well as the description, will generally refer to such devices. Other shapes other than rectangular shaped devices are contemplated within the scope of the disclosure including but not limited to elliptical and circular devices, irregular surfaces and volumes, and devices for which the rotation axis passes through the body structure, may be beneficial for specific applications.

It is contemplated within the scope of the disclosure that mixing may be performed by shaking within a centripetal system. For example in one embodiment, the centripetal system may be programmed to execute a sequence of accelerations, such as to about 1000 rpm, in one direction followed by a sudden deceleration in the alternate direction. As another example, the acceleration could be applied onto a rotating rotor, by means of magnets, electromagnets, springs or mechanical elements. The rotor could resonate accordingly and generate an oscillation, energized by the rotation, that induces enhanced mixing of the samples. This may allow for a number of reagents, samples, biological samples, or the like to be mixed together within the tiles in a centripetal system, as well as resuspension of particles contained in a liquid.

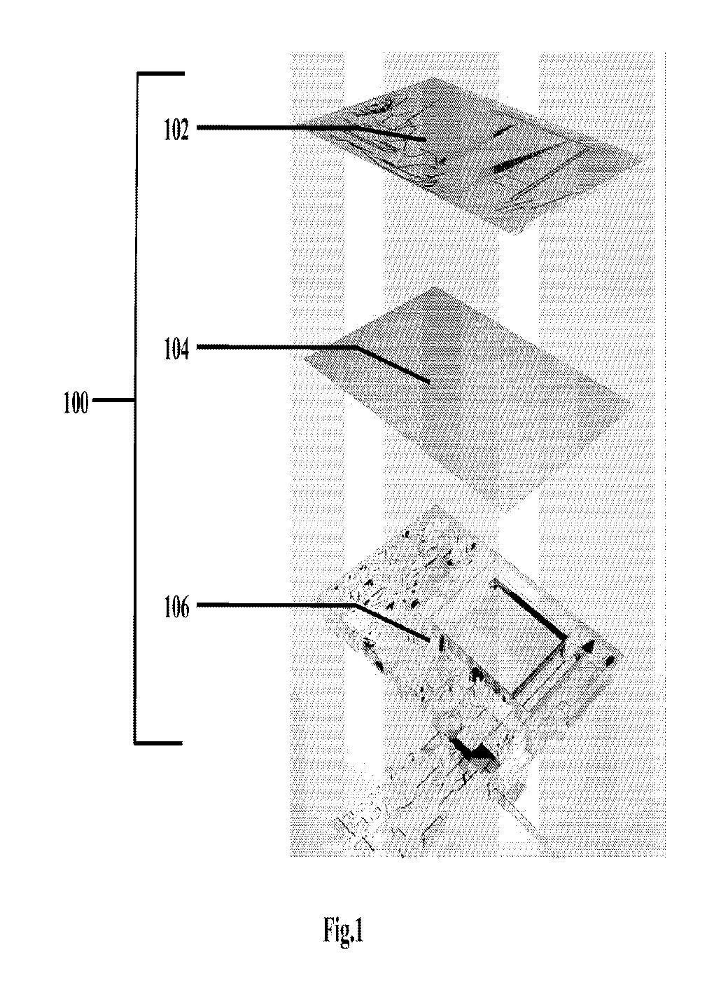

Turning to FIG. 1, in an embodiment, a tile 100 according to an embodiment of the disclosure is shown. The tile 100 is a substantially planar object formed from a first substrate 102 and a second substrate 106. It is contemplated within the scope of the disclosure that the tile 100 can be formed from more than two substrates. The substrates 102 and 106 can be of any geometric shape. The substrate 106 contains depressions, voids or protrusions that form macrofluidic structures. The substrate 102 contains depressions, voids or protrusions that form microfluidic structures. The microfluidic structures within substrate 102 may correspond to the macrofluidic structures within substrate 106 when the substrates 102 and 106 are bond together. In another embodiment the substrates 102 and 106 have a film layer 104 sandwiched between them. The film layer 104 allows for separation of voids within the substrates forming microfluidic circuits that can be placed in fluid communication with the macrofluidic structures contained within substrate 106 by perforation of the film layer 104. It is contemplated within the scope of the disclosure that the substrates 102 and 106 can be joined within the film layer 104 in between them. Further, the film layer 104 may be perforated by electromagnetic radiation from an electromagnetic generating means.

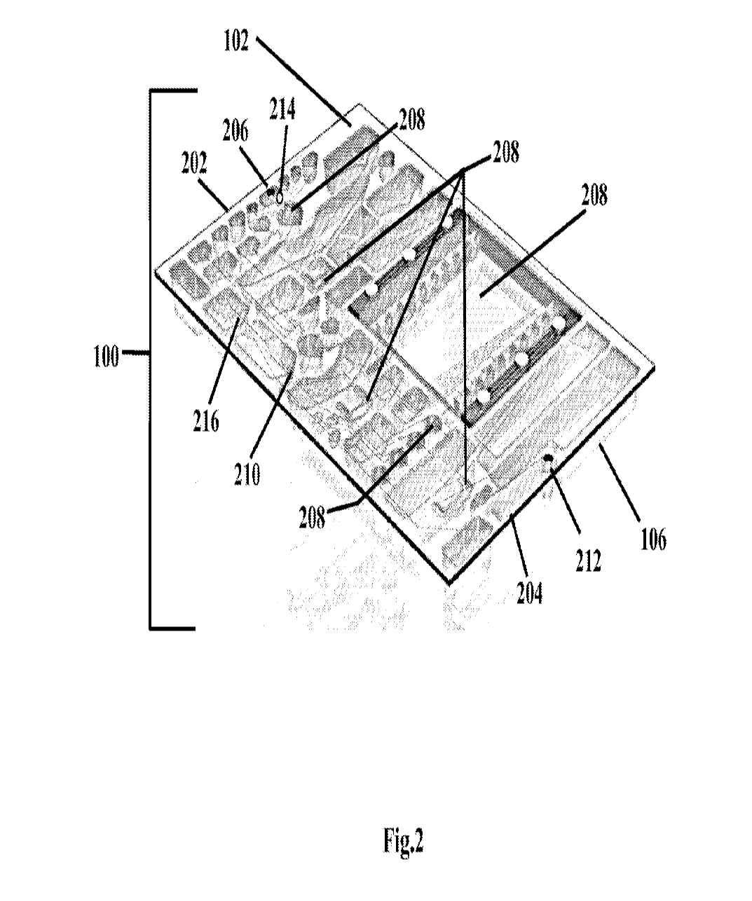

Turning to FIG. 2, in this embodiment the tile 100 is a substantially rectangular structure having an input end 202, a bottom end 204. In this embodiment the input end 202, has a plurality of input wells 206. Although the input wells 206, as shown in FIG. 2, are on the planar surface of the tile 100 it is contemplated that the input wells 206 may be placed on the ends of the tile 100 or any other place on the tile 100. The input wells 206 may be placed in fluid communication with at least one fluid handling macrofluidic structure 208 contained in substrate 106 and/or may be placed in fluid communication with at least one microfluidic circuit 210 contained within substrate 102. The bottom end 204 has a plurality of output wells 212. Although the output wells 212, as shown in FIG. 2, are on the planar surface of the tile 100 it is contemplated that the output wells 212 may be placed on the ends of the tile 100 or any other place on the tile 100. The output wells 212 may be placed in fluid communication with at least one fluid handling macrofluidic structure 208 contained in substrate 106 and/or may be placed in fluid communication with at least one microfluidic circuit 210 contained within substrate 102. It is contemplated within the scope of the disclosure that the microfluidic circuits 210 and macrofluidic structures 208 may be composed of a series of valves, chambers, reservoirs, reactors, capillaries, reaction chambers, reaction columns, elution columns, electrophoresis chambers, ion exchange matrixes, microreactors and microcapillaries, and the like. It is also contemplated within the scope of the disclosure that the series of reactors, reaction chambers, reaction columns, elution columns, electrophoresis chambers, ion exchange matrixes, microreactors and microcapillaries may be in fluid communication with a detection chamber.

The functionality of a specific microfluidic structure or circuit 210 and/or a specific macrofluidic structure 208 can be configured within the tile 100 to perform desired assays, reactions, or procedures upon a selected sample or biological sample. It is contemplated within the scope of the disclosure that any microfluidic, macrofluidic, or fluidic assay, reaction, or procedure known in the art can be configured within the tile 100 to achieve a desired functionality. Further, the tile 100 may be capable of performing such processes or procedures using the sample volumes known in the art. For example, it is contemplated that one or more of the steps and processes necessary to produce a library of DNA or RNA fragments for nucleic acid sequencing may be incorporated into the tile 100, such as DNA shearing, sonication, DNA end-repair, purification, polymerase chain reactions (PCR), quantitative polymerase chain reactions (qPCR), ligate and adapt DNA, electrophoresis, Nick-translation, amplification, and the like.

Referring to FIGS. 1 and 2, the fluid handling process starts by the opening of a valve 214 within a valving matrix 216, which could be of the type described in the patent application W004050242A2 ('242 application), wherein the film layer 104 is perforated to actuate a valve. The teachings of the '242 application are incorporated herein by reference. It is contemplated within the scope of the disclosure that the valving mechanism could also be of different types known in the art such as a mechanical valve or the like. According to an embodiment of the disclosure the microfluidic structures 210 contained within the first substrate 102 and the macrofluidic structures 208 contained within the second substrate 106 are positioned onto a different plane with respect to connecting capillaries within the valving matrix 216, and they are separated by means of the film layer 104 that can be perforated at a selected location(s) by irradiation, therefore producing a virtual valve 214 as shown in FIG. 2.

The opening of valves 214, together with the application of a non-equilibrated force onto fluids, may allow for the movement of liquids contained within the microfluidic structures 210 and/or the macrofluidic structures 208. The non-equilibrated force could be generated by means known in the art, such as centrifugation, so that the liquids are subject to a centripetal acceleration directed towards the bottom of the tile 100. Further, it is contemplated that the amount of liquid or fluid that is subject to movement may be determined by the radial position of valves 214, since only the fluid contained above the corresponding valve 214 is allowed to move through the valve 214. The process could be replicated in a plurality of subsequent layers, giving the possibility of successive dilution over various orders of magnitude, mixing two or more type of liquids together, incubating fluids for a given amount of time into the reactors, or even performing a real-time protocol over the matrix layers.

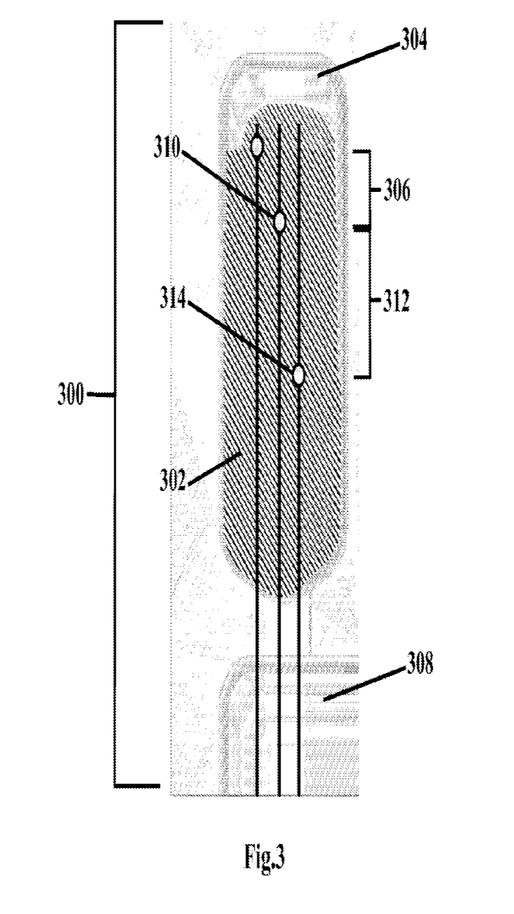

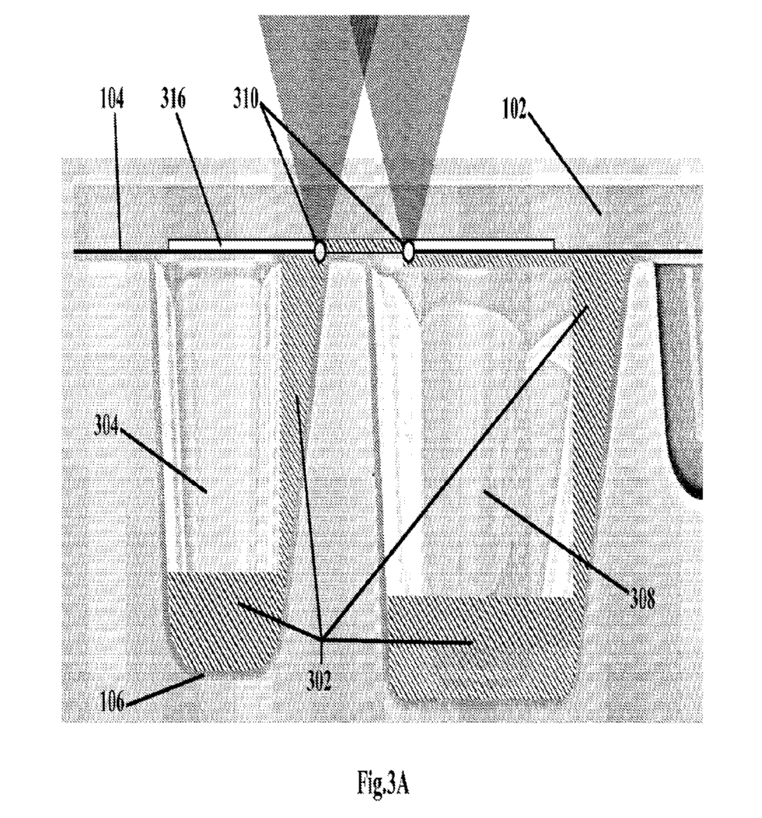

With reference to FIG. 3 in an embodiment a fluidic circuit 300 is shown illustrating one method of metering specific volumes. The fluidic circuit 300 is shown having a first state, a second state, a third state, and a reagent, sample, or biological sample 302 contained in a first chamber 304. The fluidic circuit 300 is shown in a first state with the reagent 302 filling the first chamber 304. The fluidic circuit 300 enters a second state wherein a volume 306, such as 50 nL, 50 uL, or the like, of the reagent 302 is transferred from the first chamber 304 to a second chamber 308 after a first valving 310 within a valving matrix is actuated. It is contemplated that the valve position may be computed in real-time, for example as a function of A260/A280 data.

Further, the fluidic circuit 300 enters a third state wherein a volume 312 of the reagent 302 is transferred from the first chamber 304 to the second chamber 308 after a second valving 314 within the valving matrix is actuated. The first and second chambers 304 and 308 can be microfluidic cambers or macrofluidic chambers. It is envisioned that the inventive tiles 100 can have a plurality of fluidic circuits 300 that can perform processes in different regions, by actuating the valving matrix as illustrated by the first, second, and third states of the fluidic circuit 300 as depicted in FIG. 3. Further, it is envisioned that the tile 100 can have a plurality of microfluidic or macrofluidic chambers which may contain different reagents, samples or biological samples that can perform processes or procedures, such as mixing the contents of chambers in a different chamber, reacting, purifying, separating, or the like numerous reagents, samples, or biological samples by actuating the valving matrix. The reagent 302 can be transferred from the first chamber 304 to the second chamber 308 in a desired amount or volume. The desired volume can be calculated based on the volume of the first chamber 304 and the position of the valving 310 and/or 314. Although FIG. 3 shows three states, it is envisioned that the fluidic circuits 300 can have any number of different states.

FIG. 3A illustrates another embodiment showing a side or cross-sectional view of transferring a reagent, sample, or biological sample 302 contained in a first macrofluidic chamber 304 of substrate 106 to a second macrofluidic chamber 308 of substrate 106 within the tile 100. The fluid handling process is initiated by actuating valves 310 through perforation of the film 104. The actuation of valves 310 bring the first macrofluidic chamber 304 into fluid communication with the second macrofluidic chamber 308 through a microfluidic circuit 316 within substrate 102. The application of a non-equilibrated force onto the tile 100, may allow for the movement of the reagent, sample, or biological sample 302 contained within the first macrofluidic chamber 304 to the second macrofluidic chamber 308.

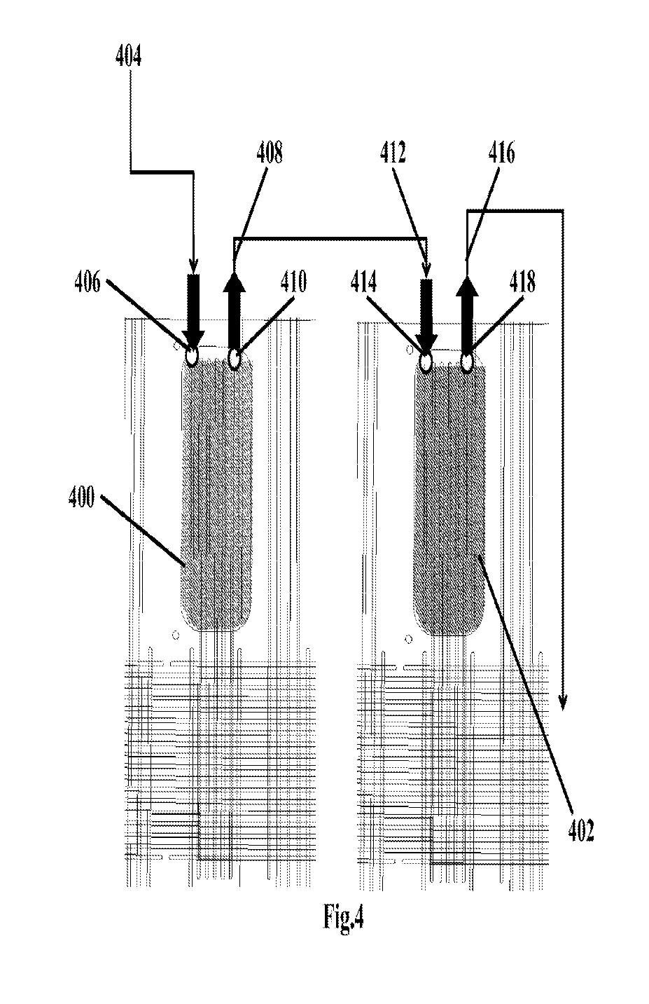

FIG. 4 illustrates an embodiment showing a method of filling a first chamber 400 and a second chamber 402 serially within a fluidic circuit. A reagent, including a suspension or an emulsion, is introduced into the first chamber 400 through a first inlet 404, by actuating a valve 406 within a valving matrix together with the application of a non-equilibrated force. The reagent fills the first chamber 400 and exits the first chamber 400 through a first outlet 408, by actuating a valve 410 within the valving matrix. As the reagent exits from the first outlet 408 it enters the second chamber 402 through a second inlet 412, by actuating a valve 414 within the valving matrix. The reagent then fills the second chamber 402 and exits the second chamber 402 through a second outlet 416, by actuating a valve 418 within the valving matrix. Although FIG. 4 shows two chambers, it is contemplated that any number of chambers can be filled serially in accordance with the method as shown in FIG. 4.

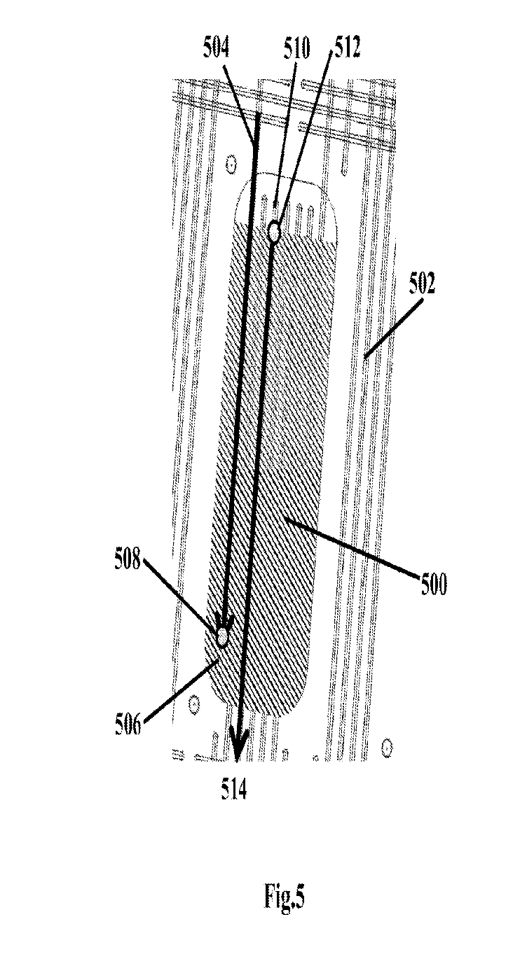

FIG. 5 illustrates an embodiment showing a method of washing a chamber 500 within a fluidic circuit 502. As shown in FIG. 5, a washing reagent or buffer 504 is introduced into the chamber 500 through a bottom inlet 506 in the chamber 500, by actuating a valve 508 within a valving matrix. The washing reagent or buffer 504 is then allowed to fill the chamber 500 to displace the previous content within chamber 500 with limited mixing/diffusion. The resulting washing reagent or buffer 504 then exits the chamber 500 through a top outlet 510, by actuating a valve 512 within the valving matrix, and flows to a purge 514. The method shown in FIG. 5 may be repeated as many times as necessary to wash the chamber 500 to a desired purity level. Further, the washing efficiency may be quantified by measure the residual fluorescence, or using any other quantification technique.

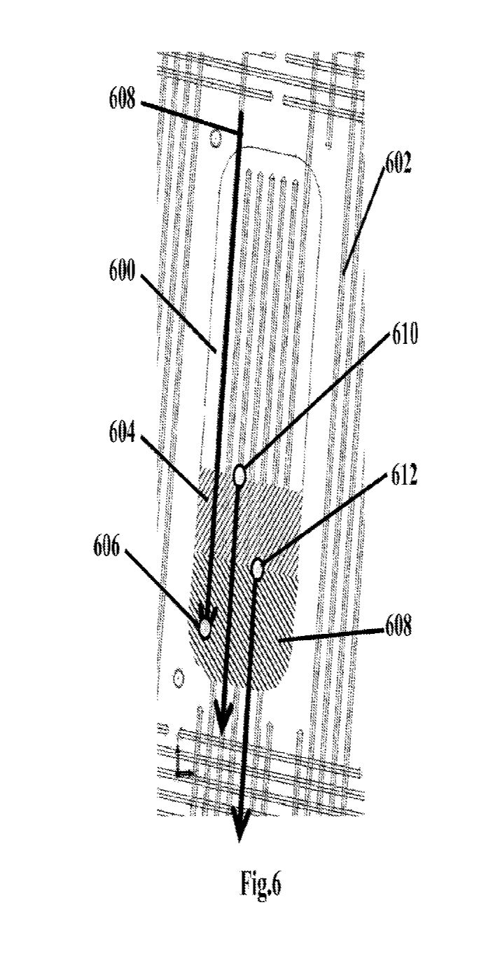

FIG. 6 illustrates an embodiment showing a method of purging/eluting a liquid 604 from a chamber 600 within a fluidic circuit 602. To purge/elute liquid 604 from chamber 600 a valve 606 is actuated within a valving matrix, allowing liquid 608 to enter the bottom of chamber 600. Liquid 608 then displaces liquid 604 toward a valve 610, which is actuated within the valving matrix. Liquid 604 is then displaced with limited mixing/diffusion out the valve 610. Additionally, a sample can be collected for examination by actuating valve 612 within the valving matrix to ensure liquid 604 has been purged out of chamber 600 to the desired purity level of liquid 604 within chamber 600. The method shown in FIG. 6 may be repeated as many times as necessary to purge/elute the chamber 600 to a desired purity level of liquid 604.

In another embodiment, one or more microfluidic chambers within a tile may be packed with beads. The beads may include but are not limited to PS streptavidin beads, polystyrene, glass, silica, nanocrystals, magnetic or non-magnetic particles, or the like In one example the beads may be transferred to the microfluidic or macrofluidic chamber by actuating a valve within the valving matrix and applying a non-equilibrated force. The beads may flow through a microcapillary or other capillary into the microfluidic chamber. It is contemplated that the microfluidic chamber may contain a sample, reagent, buffer, or the like. Additionally, the beads may be packed within the microfluidic chamber through the application of a non-equilibrated force, such as centrifugation. It is contemplated that the beads may be packed to the desired level by selecting the appropriate duration and speed of centrifugation. The possibility of using the centrifugal force for selectively moving a suspension of beads, or in alternative separating the same beads from the liquid, is enabled by the buoyancy properties of the beads with respect to the liquid itself and the limited diffusion speed of particles with large mass. The combination of the embodiments previously described enables the transfer of beads suspensions into a given chamber, the distribution of a sample onto the same chamber so that the sample can interact specifically with the beads, the selective washing of the sample without removal of the beads from the chamber, the addition of an elution buffer capable of collect the specific part of the sample which has been captured by the beads, and the collection of the eluate for further processing. This procedure has a number of applications in molecular diagnostics, nucleic acid sample preparation, the performance of immunoassays and the like.

It is further contemplated within the scope of the disclosure that a sample, reagent, biological sample, other fluid, or the like may be permeated through the packed beads in the microfluidic chamber. In one example the elution methods described above with reference to FIG. 6 may be performed in the packed microfluidic chamber through bottom filling and allowing the liquid to permeate the packed beads and flow through the packed beads. In another example the washing methods described above with reference to FIG. 5 may be performed in the packed microfluidic chamber through bottom filling the microfluidic chamber with a washing buffer. In another example instead of the washing buffer being introduced a reagent may be introduced and allowed to permeate and flow through the packed beads for the purpose of binding. Further, it is contemplated within the scope of the disclosure that instead of allowing the liquid to permeate and flow through the packed beads, the beads may be allowed to diffuse into the liquid.

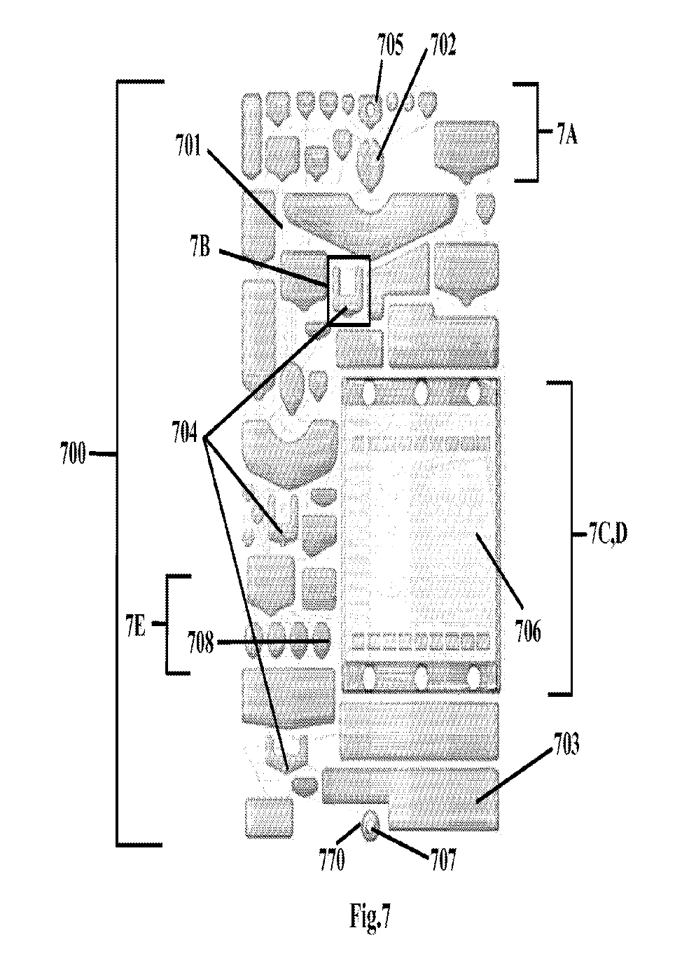

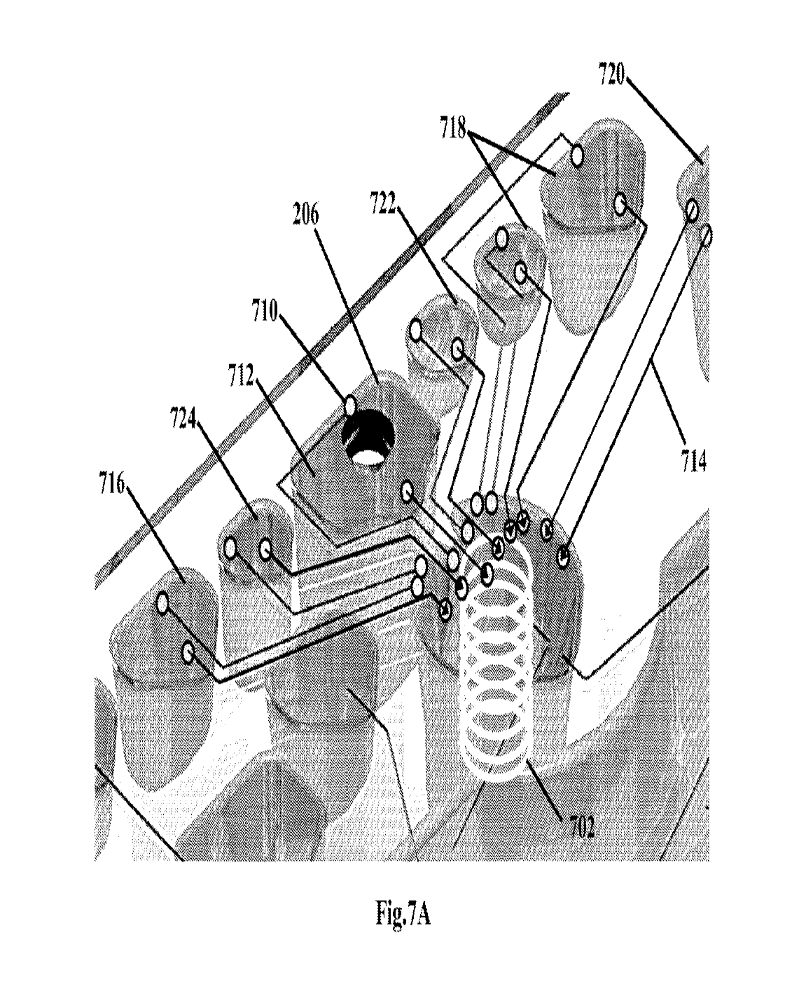

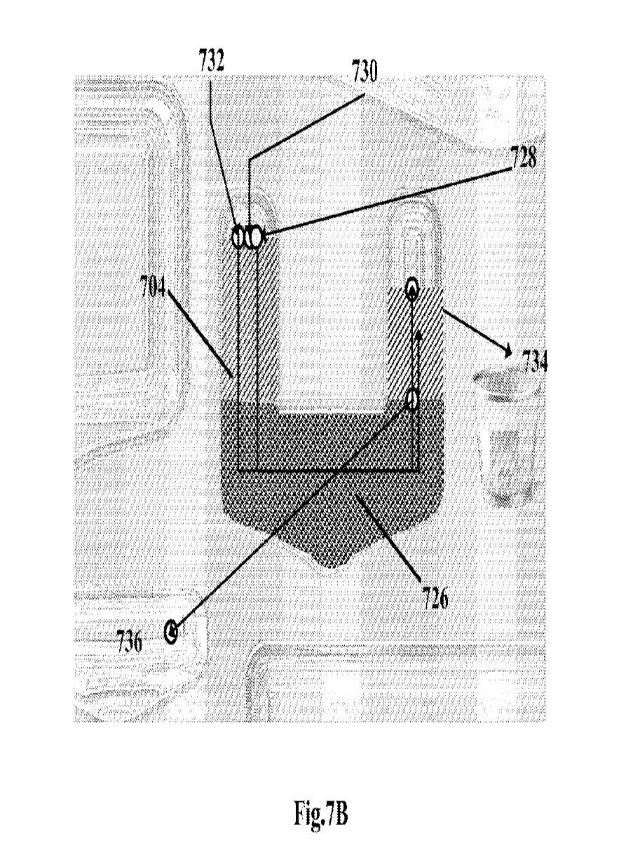

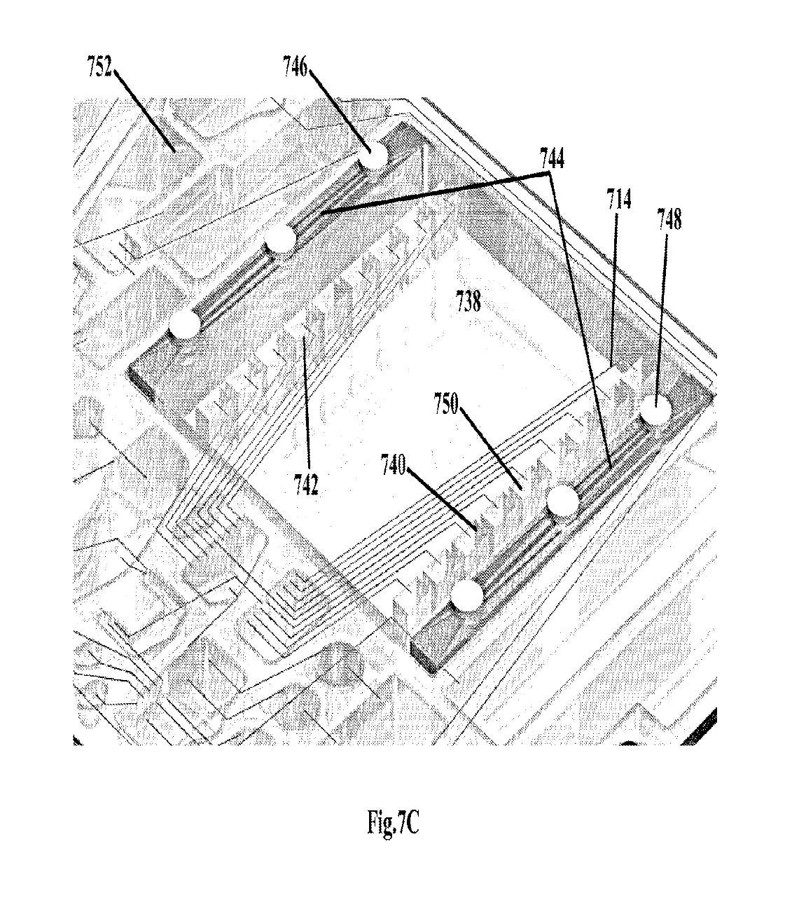

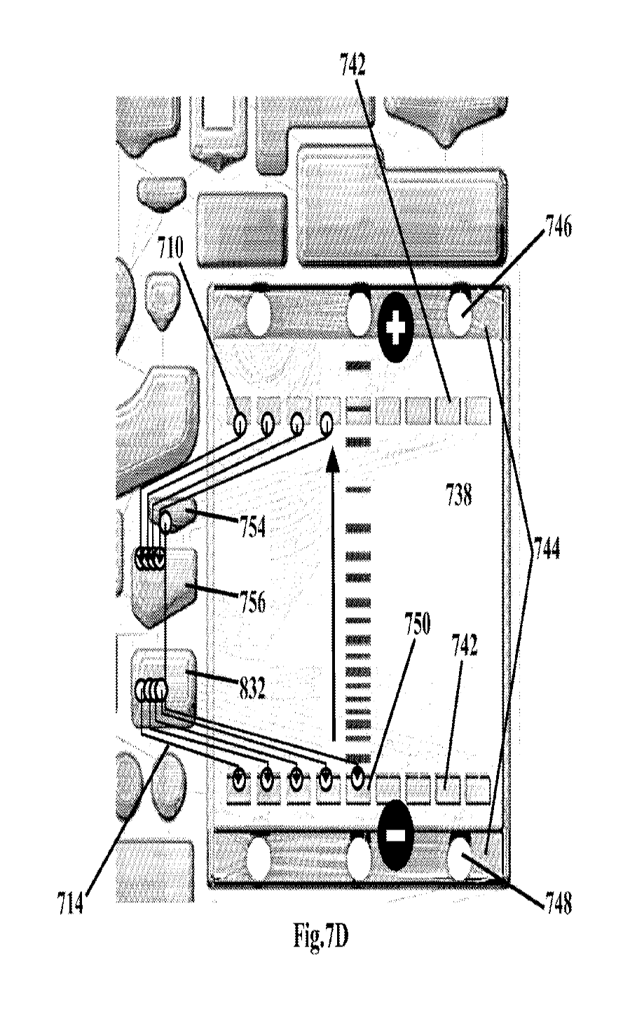

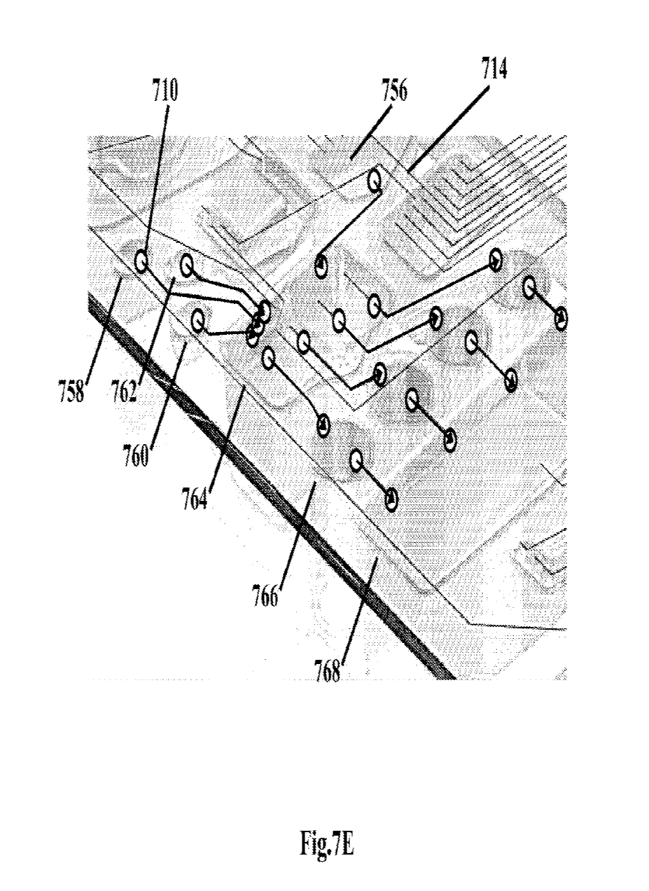

In another embodiment, FIG. 7 illustrates a fluidic tile 700 which may be programmed to generate a nucleic acid fragment library for sequencing—by means of a centripetal system—to be fed for example into a SOLiD™ 3 platform or to be used for platforms adopting the in-vitro clonal amplification methodology. The fluidic tile 700 can use the same liquid volumes known in the art in preparing a nucleic acid fragment library through the integration of microfluidics with macrofluidics. Through the use of a centripetal system having a 6 tile rotor and 3 incubation posts it may be possible to produce more than 12 libraries per day, by generating 6 libraries in 6 hours.

In this embodiment, the tile 700 includes a microfluidic substrate 701 and a macrofluidic substrate 703. The microfluidic substrate 701 and the macrofluidic substrate 703 may be separated by a film layer. The tile 700 may also include input ports 705, and output ports 707. The microfluidic substrate 701 and the macrofluidic substrate 703 may be placed in fluid communication by perforation of the film layer. The fluidic tile 700 can be programmed to perform the processes necessary to create a nucleic acid fragment library. As shown in FIG. 7, the macrofluidic substrate 703 of the fluidic tile 700 may include a plurality of macrofluidic structures such as but not limited to chambers for housing, mixing, reacting, detecting, quantitating, or any other process known in the art reagents, samples, or biological samples.

More specifically, the tile 700 may include, but is not limited to sonication chambers 702 for DNA shearing, purification chambers 704, gel electrophoresis chambers 706, and PCR chambers 708. The microfluidic substrate 701 may include microfluidic structures such as but not limited to capillaries, chambers, microreactors, microcapillaries, and the like. The macrofluidic structures within the macrofluidic substrate 703 and the microfluidic structures within the microfluidic substrate 701 may correspond to each other forming fluidic circuits that can be placed in fluid communication.

The tile 700 may include, but is not limited to one or more of the following processes DNA shearing, sonication, DNA end-repair, purification, polymerase chain reactions (PCR), quantitative polymerase chain reactions (qPCR), ligate and adapt DNA, electrophoresis, Nick-translation, amplification, and the like. Some of the processes may need to be performed at rest, such processes may include but are not limited to incubation, gel electrophoresis, and PCR. Some other processes may be performed while the centripetal system is active, such process may include buy are not limited to fluidics, purification, mixing, and quantitation through A260/A280. As described below the processes are described in order, however it is contemplated that the processes may be performed in any order or concurrently.

### DNA Shearing and End-Repair:

Turning to FIGS. 7A, an embodiment of the sonication chamber for DNA shearing and end-repair is illustrated. It is contemplated that sonication can be performed within the sonication chamber using a cup-horn, or any other device known in the art. In one embodiment, sonication may be performed using a cup-horn focused sonication by water immersion. Some of the benefits of cup-horn focused sonication by water immersion may include, but are not limited to efficient energy transfer, the ability to limit the energy diffused into the neighboring samples, the ability to limit liquid movements and bubble formation in the chambers, the high energy density may provide for an efficient DNA fragment distribution, and it may provide for easy integration and cooling. Although this embodiment shears DNA through sonication, it is envisioned that alternative shearing means may be used including, but not limited to nebulization, hydrodynamic shearing, or any other means known in the art.

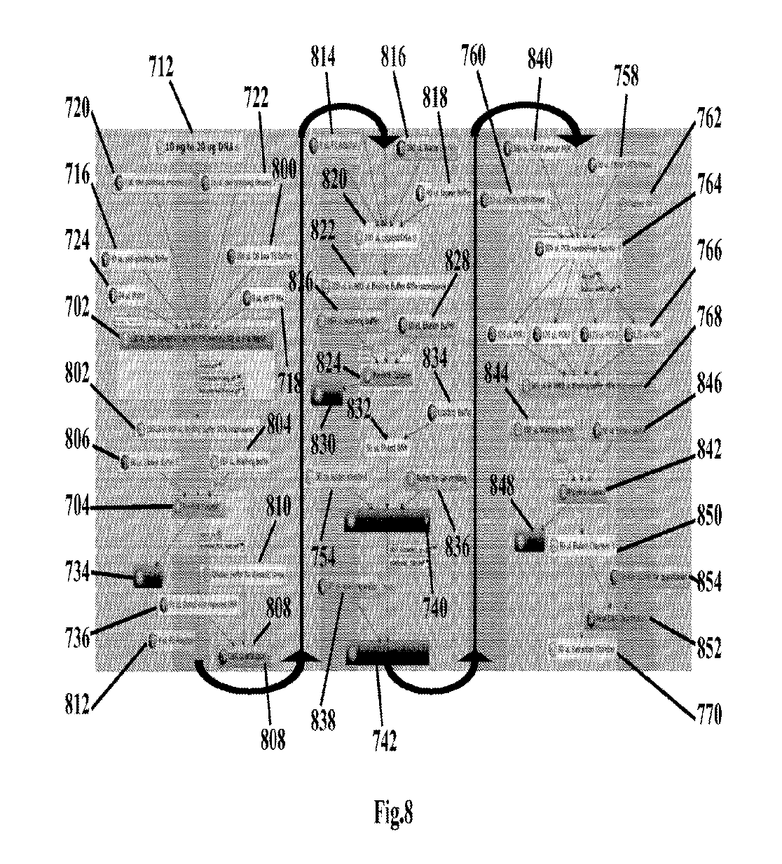

FIG. 8 illustrates the steps of preparing a nucleic acid fragment library, in which each box represents a macrofluidic chamber and each dashed line represents actuation of a valve and a fluidic transfer through a microfluidic capillary. Referencing FIGS. 7A and 8, to shear DNA within tile 700 valves 710 may be actuated within the valving matrix placing a macrofluidic loading chamber 712 and chamber 800 in fluid communication with the sonication chamber 702 through microfluidic capillaries 714. In this embodiment about 10 ng-20 ug of the sample DNA within the chamber 712 and an amount of low TE buffer within chamber 800 sufficient to dilute the sample DNA to about 100 uL may be transferred to the sonication chamber 702 by the application of a non-equilibrated force. It is contemplated that the DNA may be sheared in the sonication chamber at a temperature of about 5-30° C., for about 60 seconds, using a sweeping frequency, however any method known in the art may be used.

Following DNA shearing the fragmented DNA is end-repaired. To end-repair the DNA fragments additional valves 710 may be actuated within the valving matrix to place end-repair reagents and the fragmented DNA chambers in fluid communication through microfluidic capillaries 714. In this embodiment the end-repair reagents contained with the macrofluidic chambers of tile 700 may include, but are not limited to an end polishing buffer within a chamber 716, a dNTP mix within a chamber 718, an end polishing Enzyme 1 within a chamber 720, an end polishing Enzyme 2 within a chamber 722, and a nuclease free water within a chamber 724. Actuation of the valves 710 together with the application of a non-equilibrated force may allow about 40 uL of the end polishing buffer within chamber 716, about 8 uL of the dNTP mix within chamber 718, about 4 uL of the end polishing Enzyme 1 within chamber 720, about 16 uL of the end polishing Enzyme 2 within chamber 722, and about 32 uL of the nuclease free water within chamber 724 to be mixed with the fragmented DNA in chamber 702. It is contemplated that this mixture may be incubated at room temperature for about 30 minutes. Further, it is contemplated that the DNA end-repair procedure can be performed within the tile 700 with the desired amount of any end-repair reagents known in the art, or through any DNA end-repair process known in the art.

### Purification Process:

In another illustrative embodiment purification of end-repaired DNA may be performed within tile 700. After DNA end-repairing is completed the end-repaired DNA may be prepared for purification. To prepare the end-repaired DNA for purification the valves 710 may actuated within the valving matrix to place chamber 702 in fluid communication with a chamber 802 through microfluidic capillaries 714. The chamber 802 may contain about 800 uL or about 4 volumes of a binding buffer with 55% isopropanol. It is contemplated that chamber 802 may contain any other buffer, reagent, solution, sample, or biological sample known in the art for preparation of end-repaired DNA for purification. To initiate the mixing of the end-repaired DNA with the buffer valves 710 are actuated within the valving matrix and a non-equilibrated force is applied to transfer about 200 uL of the end-repaired DNA from chamber 702 to chamber 802.

Turning to FIG. 7B, an embodiment of the purification chamber 704 is illustrated. In this embodiment the purification means is a column that is about 50 uL, packed with silica purification beads 726 having a bead packing of about 90%, and run at about 10,000 g centrifugation to achieve a high recovery efficiency. It is contemplated that multiple purification methods may be utilized in any size column, any packing value, and alternative purification means may be used such as, but not limited to silica beads, frits, coated beads, ion exchange resins, and monoliths, or any other means known in the art. It is contemplated that the liquid processed through the column may be processed continuously or in multiple baths. Additionally, it is contemplated that the column may be run at speeds lower than 10,000 g centrifugation. Referencing FIGS. 7B and 8, purification through purification chamber 704 within tile 700 may be initiated through actuation of valves 710 within the valving matrix placing the chamber 704 in fluid communication with additional macrofluidic chambers with the tile 700 through microfluidic capillaries 714. The application of a non-equilibrated force may cause the reagents, samples, or biological samples within the macrofluidic chambers to flow through the chamber 704.

In this embodiment the end-repaired DNA is purified in accordance with the SOLiD™ 3 methodology, however, it is contemplated that any other purification methodology known in the art may be incorporated into the tile 700. Actuation of valves 710 within the valving matrix may place the chamber 704 in fluid communication with chamber 802 containing the end-repaired DNA in buffer 728, a chamber 804 containing a washing buffer 730, and a chamber 806 containing an elution buffer 732 through microfluidic capillaries 714. Application of a non-equilibrated force may cause about 700-800 uL of the end-repaired DNA in buffer 728 in chamber 802 to flow through the microfluidic capillaries 714 into chamber 704. Following addition of the end-repaired DNA in buffer 728 to chamber 704 about 650 uL of the washing buffer 730 in chamber 804 may be transferred to chamber 704, followed by the transfer of about 50 uL of the elution buffer 732 in chamber 806. As the end-repaired DNA in buffer 728, migrates through the column the waste may be directed to a chamber 734 and the purified/eluted DNA may be directed to a chamber 736. The waste and purified/eluted DNA may be directed to chambers 734 and 736 by the actuation of valves 710 within the valving matrix and the application of non-equilibrated force.

### DNA Quantitation:

In another embodiment DNA quantitation may be performed with tile 700. The tile 700 may be programmed to allow for absorbance measurements to be taken. Optionally one may perform DNA quantitation on the purified DNA in chamber 736. To perform DNA quantitation of the purified DNA within chamber 736 a sample from chamber 736 and a dilution buffer within a chamber 810 may be transferred to a chamber 808 within the tile 700. To transfer a sample from chamber 736 and the dilution buffer from chamber 810 to chamber 808 valve 710 within the valving matrix may be actuated placing chambers 736 and 810 in fluid communication with chamber 808. Through the application of a non-equilibrated force a sample from chamber 736 and a dilution buffer from chamber 810 may be transferred to chamber 808 through microfluidic capillaries 714. It is contemplate that the dilution buffer may be any buffer that is within the dynamic range being used.

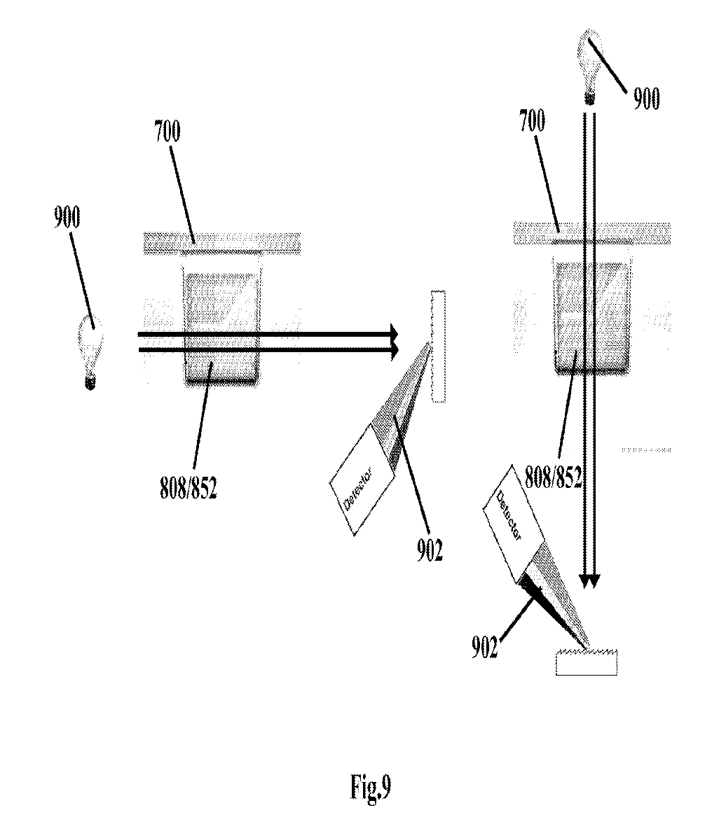

FIG. 9 illustrates an embodiment of DNA quantitation. In this embodiment A260/A280 nm DNA quantitation may be used. However, it is contemplated that any other method of DNA quantitation known in the art may be used and programmed into tile 700, such as but not limited to qPCR, Sybr/RTPCR, well known OEM solutions, and the like. The DNA quantitation may be performed through the chamber 808 without having to remove the from the tile 700. As shown in FIG. 9, in one embodiment a light 900 may be directed through the chamber 808 toward a detector 902. Additionally, in another embodiment the light 900 may be directed through the planar surface of the tile 700 and through the chamber 808 toward the detector 902. In this embodiment DNA quantitation may provide for optimal optical inspection conditions, a long optical path, different geometries for different performances/resolution, and the like. It is contemplated that the sample may be removed and DNA quantitation may be performed on the sample in accordance with any means known in the art.

Further, it is contemplated that measurements may be taken in real-time. Metered volumes may be determined by the height of a single valve within the dispensing chamber. It may be possible to modify, in real-time, the position of that valve according to the outcome of a previous measurement, therefore modulating the volume of the extracted/dispensed liquid according to the desired logic in a given path structure. Dynamic ranges up to 10× may be achieved in a single extraction. Further, larger dynamic ranges may be achieved by using one or more resources known in the art such as but not limited to multi-step dilution like in IC50.

### Ligate and Adaptors to DNA:

In another embodiment the addition of ligates and adaptors to DNA may be performed in tile 700. Referencing FIGS. 7B and 8, in another embodiment after purification of the DNA in chamber 704 the purified DNA in chamber 736 may be ligated and adapted. In this embodiment the DNA may be ligated and adapted in accordance with the SOLiD™ 3 methodology, however, it is contemplated that any other ligation and adaption methodology known in the art may be incorporated into the tile 700. In accordance with the SOLiD™ 3 methodology the DNA in chamber 736 may be mixed with a P1 adaptor, a P2 adaptor, a ligase buffer, and a nuclease free water. The amount of P1 and P2 adaptors may be calculated in accordance with the SOLiD™ 3 methodology through the following equations:

$$X pmol \text{/} ug DNA = 1 ug DNA \times \frac{{10}^{6} pg}{1 ug} \times \frac{1 pmol}{660 pg} \times \frac{1}{Average inert size}$$

$$Y uL adaptar needed = 1 ug DNA \times \frac{Xpmol}{1 ug DNA} \times 30 \times \frac{1 uL adapter needed}{50 pmol} .$$

Initiation of the mixing may occur by actuation of valves 710 within the valving matrix to place chamber 736 containing the purified DNA, a chamber 812 containing the P2 adaptor, a chamber 814 containing the P1 adaptor, a chamber 816 containing the water, and a chamber 818 containing the ligase buffer in fluid communication with a mixing chamber 820, within the tile 700. Application of a non-equilibrated force may cause the appropriate amounts of about 40-50 uL of the purified DNA in chamber 736, about YuL of the P1 adaptor in chamber 814, about YuL of the P2 adaptor in chamber 812, the water in chamber 816, and about 40 uL of the ligase buffer in chamber 818 to be transferred through microfluidic capillaries 714 to the mixing chamber 820. It is contemplated that the mixture may be incubated at room temperature for about 15 min. However, it is contemplated that the mixture may be incubated at any temperature and duration used to ligate and adapt DNA.

### Purification:

In another embodiment purification of ligated and adapted DNA may be performed within tile 700. The ligated and adapted DNA may be prepared for purification within tile 700. To prepare the ligated and adapted DNA for purification the valves 710 may actuated within the valving matrix to place chamber 820 in fluid communication with a chamber 822 through microfluidic capillaries 714. The chamber 822 may contain about 800 uL or about 4 volumes of a binding buffer with about 40% isopropanol. It is contemplated that chamber 822 may contain any other buffer, reagent, solution, sample, or biological sample known in the art for preparation of ligated and adapted DNA for purification. To initiate the mixing of the ligated and adapted DNA with the buffer valves 710 are actuated within the valving matrix and a non-equilibrated force is applied to transfer about 200 uL of the ligated and adapted DNA from chamber 820 to chamber 822.

In this embodiment the purification means is a column similar to that illustrated in FIG. 7B that is about 50 uL, packed with silica purification beads having a bead packing of about 90%, and run at about 10,000 g centrifugation to achieve a high recovery efficiency. It is contemplated that multiple purification methods may be utilized in any size column, any packing value, and alternative purification means may be used such as, but not limited to silica beads, frits, coated beads, ion exchange resins, and monoliths, or any other means known in the art. It is contemplated that the liquid processed through the column may be processed continuously or in multiple baths. Additionally, it is contemplated that the column may be run at speeds lower than 10,000 g centrifugation.

Referencing FIG. 8, purification of ligated and adapted DNA in buffer may be conducted through purification chamber 824 within tile 700. Purification may be initiated through actuation of valves 710 within the valving matrix placing the chamber 824 in fluid communication with additional macrofluidic chambers with the tile 700 through microfluidic capillaries 714. The application of a non-equilibrated force may cause the reagents, samples, or biological samples within the macrofluidic chambers to flow through the chamber 824.

In this embodiment the ligated and adapted DNA is purified in accordance with the SOLiD™ 3 methodology, however, it is contemplated that any other purification methodology known in the art may be incorporated into the tile 700. Actuation of valves 710 within the valving matrix may place the chamber 824 in fluid communication with chamber 822 containing the ligated and adapted DNA in buffer, a chamber 826 containing a washing buffer, and a chamber 828 containing an elution buffer through microfluidic capillaries 714. Application of a non-equilibrated force may cause about 700-800 uL of the ligated and adapted DNA in buffer in chamber 822 to flow through the micro fluidic capillaries 714 into chamber 824. Following addition of the ligated and adapted DNA in buffer to chamber 824 about 650 uL of the washing buffer in chamber 826 may be transferred to chamber 824, followed by the transfer of about 50 uL of the elution buffer in chamber 828. As the ligated and adapted DNA in buffer migrates through the column the waste may be directed to a chamber 830 and the purified/eluted DNA may be directed to a chamber 832. The waste and purified/eluted DNA may be directed to chambers 830 and 832 by the actuation of valves 710 within the valving matrix and the application of non-equilibrated force.

### Size-Selecting the DNA:

In another embodiment a means for size selecting the DNA, such as through gel electrophoresis may be incorporated into tile 700. Referring to FIGS. 7 and 7C, an embodiment of gel electrophoresis is illustrated within tile 700. The substrate 703 of tile 700 may include a gel chamber 738 which may house a gel matrix. The gel matrix may be composed of any gel known in the art, such as but not limited to a cross-linked polymer, acrylamide and a cross-linker, polyacrylamide, agar, bovine gelatine, and the like. At one end of the gel chamber 738 there may be a plurality of loading wells 740, and opposite the loading wells 740 at the other end of the gel chamber 738 there may be a plurality of collection wells 742. The loading wells 740 and the collection wells 742 within the gel chamber 738 may be placed in fluid communication with additional wells, chambers, or processes within the tile 700 through microfluidic capillaries 714 within substrate 701 by actuation of valves 710 within the valving matrix. It is contemplated that the loading wells 740 may include one or more ladder lanes 750, which may be placed in fluid communication with chambers containing one or more DNA ladders within the tile 700 through microfluidic capillaries 714 within substrate 701 by actuation of valves 710 within the valving matrix. At both ends of the gel chamber 738 there may be ion exchange matrixes 744. At one end of the gel chamber 738 there may be an anode 746 connected to the ion exchange matrix 744. Opposite the anode 746 at the other end of the gel chamber there may be a cathode 748 connected to the ion exchange matrix 744. Additionally, the tile 700 may include one or more chambers 752, which may contain one or more electrophoresis gel buffers. The chambers 752 may be placed in fluid communication with the gel chamber 738 within the tile 700 through microfluidic capillaries 714 within substrate 701 by actuation of valves 710 within the valving 10 matrix. As shown in FIG. 7C the gel electrophoreses process in tile 700 is programmed to be used for size selecting DNA. However it is contemplated that the gel-electrophoresis process may be programmed for any other purpose of in any other manner known in the art.

Referencing FIGS. 7D and 8, an embodiment of performing gel electrophoresis within tile 700 is illustrated. In this embodiment, the gel electrophoresis process may be initiated by actuating valves 710 within the valving matrix together with the application of a non-equilibrated force to transfer a loading buffer within chamber 834 to chamber 832 which contains the eluted DNA. Actuation of valves 710 within the valving matrix together with the application of a non-equilibrated force may transfer the eluted DNA within chamber 832 and a DNA ladder within chamber 754 to the loading wells 740 and ladder lanes 750 through microfluidic capillaries 714 within the tile 700. In this embodiment a 50 bp DNA ladder may be used, however it is contemplated that any DNA ladder known in the art may be used. Further, a buffer for gel refilling within a chamber 836 may be transferred to the loading wells 740 through microfluidic capillaries 714 by actuation of valves 710 within the valving matrix together with the application of a non-equilibrated force. Optionally, the size selected DNA contained within collection wells 742 may be transferred to a chamber 756 through microfluidic capillaries 714 by actuation of valves 710 within the valving matrix together with the application of a non-equilibrated force. Additionally, a washing buffer in a chamber 838 may be transferred to collection wells 742 through microfluidic capillaries 714 by actuation of valves 710 within the valving matrix together with the application of a non-equilibrated force. Although in this embodiment gel electrophoresis is performed prior to Nick-translation, it is contemplated that tile 700 may be programmed to perform gel electrophoresis after Nick-translation or at any other time within any other process or procedure known in the art. Further, it is contemplated that concurrent imaging/readout may be possible and parallel samples may be possible by asynchronous extractions.

Nick-Translation:

In another embodiment tile 700 may be programmed to perform Nick translation. Referencing FIG. 7E, an embodiment of tile 700 is shown illustrating chambers for performing Nick-translation and PCRs. In this embodiment tile 700 is programmed to perform Nick-translation and PCRs on size-selected DNA in accordance with the SOLiDI'm 3 methodology. However, it is contemplated that tile 700 may be programmed to perform Nick-translation and PCRs on any other reagent, sample, biological sample, and the like in any manner known in the art. Referencing FIGS. 7E and 8, in this embodiment tile 700 may include the chamber 756 containing the size selected DNA; a chamber 840 containing a PCR amplification mix; a chamber 758 containing a library PCR Primer 1; a chamber 760 containing a library PCR Primer 2; a chamber 762 containing an optional reagent such as but not limited to oil, nuclease free water and the like; a chamber or PCR sample preparation reactor 764, a plurality of PCR chambers 766, and a chamber 768 for collecting the PCR output. Optionally, chamber 768 may contain a binding buffer such as but not limited to a binding buffer with 40% isopropanol. As illustrated chambers 756, 840, 758, 760, and 762 may be placed in fluid communication with chamber 764 through microfluidic capillaries 714 by actuation of valves 710 within the valving matrix. Chamber 764 may be placed in fluid communication with chambers 766 through microfluidic capillaries 714 by actuation of valves 710 within the valving matrix. Chambers 766 may be placed in fluid communication with chamber 768 through microfluidic capillaries 714 by actuation of valves 710 within the valving matrix. It is contemplated that additional chambers or the like may be programmed into tile 700 containing additional reagents known in the art. Further, it is contemplated that additional reagents known in the art may be modulated during the sample-preparation process and supplementary reagents known in the art may be added during the PCR process without contamination, such as but not limited to Mn and the like.

Referencing FIGS. 7E and 8, in another embodiment a process for performing Nick-translation and PCRs on size selected DNA in tile 700 is illustrated. The process may be initiated by actuating valves 710 within the valving matrix and applying a non-equilibrated force to transfer about 40-50 uL of the size selected DNA from chamber 756 or chambers 742; about 380-400 uL of the PCR amplification mix within chamber 840; about 1 OuL of the library PCR Primer 1 within chamber 758; about 1 OuL of the library PCR Primer 2 within chamber 760; and an amount of the oil or nuclease free water within chamber 762 to bring the total volume to about 500 uL through microfluidic capillaries 714 to chamber 764 to mix the reagents. The mixture in chamber 764 may be transferred to the PCR chambers 766. In this embodiment about 125 uL of the mixture in chamber 764 may be transferred to each of the four PCR chambers 766 through microfluidic capillaries 714 by actuating valves 710 within the valving matrix and applying a non-equilibrated force. In accordance with the SOLiD 3 methodology the mixture may be held in the PCR chambers 766 at 4° C. to store the tile for reaction of the mixture at a later time. Alternatively, the PCR chambers 766 containing the mixture may be incubated, reacted, extended denatured, annealed and/or the like. Some examples of reacting and/or incubating the mixture within chambers 766 may include but are not limited to holding at about 72° C. for about 20 min for Nick-translation, holding at about 95° C. for about 5 min for denaturing, holding at about 70° C. for about 5 min for extending, cycling at about 95° C. for about 15 sec for denaturing, cycling at about 62° C. for about 15 sec for annealing, cycling at about 70° C. for about 1 min for extending, holding or cycling at any temperature for any duration known in the art, and the like. In another embodiment it is contemplated that qPCR temperature monitoring may be achieved by the use of thermochromic dyes/crystals to monitor temperature transitions by means of and embedded camera. Further it is contemplated that controlled thermocycling may be achieved by near IR sources and the like.

### Purification:

Referencing FIGS. 7E and 8, in another embodiment purification of the PCR mixtures may be performed within tile 700. The PCR mixtures may be prepared for purification within tile 700. To prepare the PCR mixtures for purification valves 710 may be actuated within the valving matrix to place chambers 766 in fluid communication with chamber 768 through microfluidic capillaries 714. The chamber 768 may contain about 1000 uL or about 4 volumes of a binding buffer with about 40% isopropanol. It is contemplated that chamber 768 may contain any other buffer, reagent, solution, sample, or biological sample known in the art for preparation of ligated and adapted DNA for purification. To initiate the mixing of the PCR mixtures with the buffer valves 710 are actuated within the valving matrix and a non-equilibrated force is applied to transfer about 125 uL of the PCR mixtures from each of the four chambers 766 to chamber 768.

In this embodiment the purification means is a column similar to that illustrated in FIG. 7B that is about 50 uL, packed with silica purification beads having a bead packing of about 90%, and run at about 10,000 g centrifugation to achieve a high recovery efficiency. It is contemplated that multiple purification methods may be utilized in any size column, any packing value, and alternative purification means may be used such as, but not limited to silica beads, frits, coated beads, ion exchange resins, and monoliths, or any other means known in the art. It is contemplated that the liquid processed through the column may be processed continuously or in multiple baths. Additionally, it is contemplated that the column may be run at speeds lower than 10,000 g centrifugation.

Referencing FIG. 8, purification of the PCR mixtures in buffer may be conducted through purification chamber 842 within tile 700. Purification may be initiated through actuation of valves 710 within the valving matrix placing the chamber 842 in fluid communication with additional macrofluidic chambers with the tile 700 through microfluidic capillaries 714. The application of a non-equilibrated force may cause the reagents, samples, or biological samples within the macrofluidic chambers to flow through the chamber 842. This figure also provides a synoptic view of the protocol complexity that could be integrated on a tile for the specific case of nucleic acid fragment library preparation for a SOLID' 3 system. This graphical description documents the implementation of the standard fragment library protocol described in the Applied Biosystems SOLiDI'm 3 quick reference guide (Part Number 4407414 Rev. B 02/2009).

In this embodiment the PCR mixtures are purified in accordance with the SOLiDI'm 3 methodology, however, it is contemplated that any other purification methodology known in the art may be incorporated into the tile 700. Actuation of valves 710 within the valving matrix may place the chamber 842 in fluid communication with chamber 768 containing the PCR mixtures in buffer, a chamber 844 containing a washing buffer, and a chamber 846 containing an elution buffer through microfluidic capillaries 714. Application of a non-equilibrated force may cause the PCR mixtures in buffer in chamber 768 to flow through the micro fluidic capillaries 714 into chamber 842. Following addition of the PCR mixtures in buffer to chamber 842 about 650 uL of the washing buffer in chamber 844 may be transferred to chamber 842, followed by the transfer of about 50 uL of the elution buffer in chamber 846. As the PCR mixtures in buffer migrate through the column the waste may be directed to a chamber 848 and the purified/eluted DNA may be directed to a chamber 850. The waste and purified/eluted DNA may be directed to chambers 848 and 850 by the actuation of valves 710 within the valving matrix and the application of non-equilibrated force.

### Sample Collection:

Referencing FIGS. 7 and 8, in another embodiment a sample of the purified/eluted DNA in chamber 850 may be transferred to an output chamber 770 for collection. Transfer of the purified/eluted DNA in chamber 850 to the output chamber 770 may be done through microfluidic capillaries 714 by actuation of valves 710 within the valving matrix together with the application of a non-equilibrated force. From output chamber 770 a sample may be collected.

### DNA Quantitation:

As discussed above, Referencing FIGS. 7 and 8, in another embodiment DNA quantitation may be performed with tile 700. Optionally one may perform DNA quantitation on the purified/eluted DNA in chamber 850. To perform DNA quantitation of the purified DNA within chamber 850 a sample from chamber 850 and a dilution buffer within a chamber 854 may be transferred to a chamber 852 within the tile 700. To transfer a sample from chamber 850 and the dilution buffer from chamber 854 to chamber 852 valves 710 within the valving matrix may be actuated placing chambers 850 and 854 in fluid communication with chamber 852. Through the application of a non-equilibrated force a sample from chamber 850 and a dilution buffer from chamber 854 may be transferred to chamber 852 through microfluidic capillaries 714. It is contemplated that the dilution buffer may be any buffer that is within the dynamic range being used.

Referencing FIG. 9, in this embodiment A260/A280 nm DNA quantitation may be used. However, it is contemplated that any other method of DNA quantitation known in the art may be used and programmed into tile 700, such as but not limited to qPCR, Sybr/RTPCR, well known OEM solutions, and the like. The DNA quantitation may be performed through the chamber 852 without having to remove the sample from the tile 700. As shown in FIG. 9, in one embodiment a light 900 may be directed through the chamber 852 toward a detector 902. Additionally, in another embodiment the light 900 may be directed through the planar surface of the tile 700 and through the chamber 852 toward the detector 902. In this embodiment DNA quantitation may provide for optimal optical inspection conditions, a long optical path, different geometries for different performances/resolution, and the like. It is further contemplated that the sample may be removed and DNA quantitation may be performed on the sample in accordance with any means known in the art.

### Manufacture and Processing:

Tiles according to the embodiments of the disclosure may advantageously have a variety of composition and surface coatings appropriate for a particular application. Tile composition will likely be a function of structural requirements, manufacturing processes, reagent compatibility and chemical resistance properties. In particular, the microfluidic substrate and macrofluidic substrate of the tiles may be made from inorganic crystalline or amorphous materials, e.g. silicon, silica, quartz, inert metals, or from organic materials such as plastics, for example, poly(methylmethacrylate) (PMMA), acetonitrile-butadiene-styrene (ABS), polycarbonate, polyethylene, polystyrene, polyolefins, cyclo olefin polymers, polypropylene and metallocene. These may be used with unmodified or modified surfaces.

Surface properties of these materials may be modified for specific applications. Surface modification can be achieved by such methods as known in the art including by not limited to silanization, ion implantation and chemical treatment with inert-gas plasmas. It is contemplated within the scope of the disclosure that tiles can be made of composites or combinations of these materials, for example, tiles manufactured of a polymeric material having embedded therein an optically transparent surface comprising for example a detection chamber of the tile. Additional elements, for example arrays, detectors, functional devices, gels, could be also integrated into an heterogeneous macrofluidic substrate, making the integration of the device more suitable to given processes.

It is further contemplated within the scope of the disclosure that tiles can be fabricated from plastics such as polyethylene terephthalate (PET), polyethylene terephthalate modified by copolymerization (PETG), Teflon, polyethylene, polypropylene, methylmethacrylates and polycarbonates, among others, due to their ease of moulding, thermoforming, stamping and milling. It is also contemplated within the scope of the disclosure that tiles can be made of silica, glass, quartz or inert metal. The tiles having microfluidic fluidic circuits, capillaries, chambers and the like within in one illustrative embodiment can be built by joining using known bonding techniques opposing substrates having complementary macrofluidic chambers, wells, reactors, purification columns, sonication chambers, gel electrophoresis chambers and the like formed therein.

The microfluidic substrate of the embodiments of the tiles of the disclosure can be fabricated with injection molding of optically-clear or opaque adjoining substrates or partially clear or opaque substrates. The macrofluidic substrate of the embodiments of the tiles can be fabricated with thermoforming of optically-clear or opaque adjoining substrates or partially clear or opaque substrates. However, thermoforming could be equally applied to the microfluidic substrate, with significant advantages in terms of production cost and capacity, including assembly. Optical surfaces within the substrates can be used to provide means for detectionanalysis or other fluidic operations such as laser valving. Layers comprising materials other than polycarbonate can also be incorporated into the tiles.

The composition of the substrates forming the tile depends primarily on the specific application and the requirements of chemical compatibility with the reagents to be used with the tile. Electrical layers and corresponding components can be incorporated in tiles requiring electric circuits, such as electrophoresis applications and electrically-controlled valves. Control devices, such as integrated circuits, laser diodes, photodiodes and resistive networks that can form selective heating or cooling areas or flexible logic structures can be incorporated into appropriately wired areas of the tile. Reagents that can be stored dry can be introduced into appropriate open chambers by spraying into reservoirs using means known in the art during fabrication of the tiles, or simply by means of depositing solid materials. In alternative or complementing the previous methods, liophilization of reagents on the macrofluidic substrate is an obvious and straightforward solution. Liquid reagents may also be injected into the appropriate reservoirs, before or after the assembly of the microfluidic and macrofluidic substrates, followed by application of a cover layer comprising a thin plastic film that may be utilized for a means of valving within the fluidic circuits within the tile.

The inventive fluidic tiles may be provided with a multiplicity of components, either fabricated directly onto the substrates forming the tile, or placed on the tile as prefabricated modules. In addition to the integral fluidic components, certain devices and elements can be located external to the tile, optimally positioned on a component of the tile, or placed in contact with the tile either while rotating within a rotation device or when at rest with a brick formation or with a singular tile. Fluidic components optimally comprising the tiles according to the disclosure include but are not limited to detection chambers, reservoirs, valving mechanisms, detectors, sensors, temperature control elements, filters, mixing elements, and control systems.

Additionally, it is contemplated that the tile may contain a cover film on the outside of the tile, covering a chamber. The cover film may allow for sample collection or pre-loading sample solutions in to a chamber by puncturing the cover film, which in turn may allow for intermediate storage of the tile prior to sample collection. Further, the cover film may allow for more efficient and faster radiative heat transfer, which may allow for more efficient PCR cycle cooling. The cover film may also allow for optimal optical access to a sample within the chamber.

In one embodiment the microfluidic substrate of the tiles of the disclosure can be fabricated by injection molding of a cyclo olefin polymer (COP), and, the macrofluidic substrate of the tiles of the disclosure can be fabricated by thermoforming a PET/COP/Multilayer or a PP layer. The microfluidic substrate may have a thickness of about 1.1 m and dimensions of about 80 by 120 mm, for example equivalent to a microplate footprint for compatibility purposes. The microfluidic substrate may contain about 120 capillaries per 100 by 100 um section, wherein the gap between the capillaries may be equal to or greater than 500 um. Further, the microfluidic substrate may contain rivets for the purpose of providing electrical contacts for gel electrophoresis. The macrofluidic substrate may have a thickness of about 50-320 um, which may enable efficient heat transfer through the macrofluidic substrate, and dimensions of about 80 by 120 mm. The macrofluidic substrate may contain about 48 cavities that correspond to the capillaries of the microfluidic substrate, wherein the gap between the cavities may be equal to or greater than 1 mm. The macrofluidic substrate could equally be a single piece, or a plurality of substrates with different properties, optimized for example for storage, surface properties, thermal properties, mechanical and electrical performances. In this embodiment the microfluidic substrate and the macrofluidic substrate are separated by a film layer. The film layer may be a simple unstructured foil having a thickness of about Bum. The film layer may be made of a COP with a carbon black dye. Further, the film layer may be perforated by laser valving to place the capillaries within the microfluidic substrate and the cavities within the macrofluidic substrate in fluid communication. It is contemplated that sealing of the separate components, the microfluidic and macrofluidic substrates, to keep them from becoming contaminated may be achieved through the use of thermobonding, lamination, pressure sensitive adhesives, activated adhesives, and the like.

In one embodiment the film layer or perforation layer may separate the plurality of microfluidic components or structures from the plurality of macrofluidic components or structures or additional components or structures. The structure of the film layer could be 30 homogeneous or heterogeneous, for example including multilayer and coatings. According to the disclosure the film layer or perforation layer may be comprised of a polymeric compound such as Poly(rnethyl methacrylate), or other material such as Low Density Polyethylene (LDPE), Linear Low Density Polyethylene (LLDPE), High Density Polyethylene HDPE), Polyethylene Teraphathalate (PET), Polyethylene (PE), polycarbonate (PC), Polyethylene Terephthalate Glycol (PETG), Polystyrene (PS), Ethyl Vinyl Acetate (EVA), polyethylene napthalate (PEN), Cyclic Olefin Homopolyers (COP), Cyclic Olefin Copolymers (COC), or the like. These polymers can be used singularly or in combination with each other. The use of polymers is preferred because of its ease of use and manufacturing. It is clear that other options, for example metallic foils with or without additional surface treatment, are possible.

The film layer may further comprise optical dye or other like material or layers having adsorptive properties of pre-selected electromagnetic radiation. The absorption can occur through known modifications as those used in absorbing light filters, for example including metallic foils or modifying the surface optical characteristics (n refraction index and k extinction coefficient) or by means of other surface properties like roughness, in such a way that a sufficient amount of pre-selected electromagnetic energy is absorbed with the consequence of perforation. Other technologies can make use of light absorbing globules, for example carbon-black particles, dye emulsions, nanocrystals. In addition, reflective layers, polarization changing layers, wavelength shifting layers could be used to enhance the effective absorption of electromagnetic energy.

In another embodiment, the tile may be pre-loaded with a sample, reagent, biological sample of the like. The purpose of pre-loading the tile may allow for a user to simply add the sample, reagent, biological sample or the like the user may want to process within the tile. This may allow for automated processing of a sample, reagent, biological sample or the like within the tile. In one example the macrofluidic substrate may be loaded with any sample, reagent, biological sample or the like known in the art such as but not limited to electrophoresis gel, purification column components (for example silica beads), any buffers known in the art, a PCR mix, primers, enzymes, adaptors, dNTP, and DNA ladders. In one embodiment, the tile may be pre-loaded with any sample, reagent, biological sample or the like that may be stored at about 4 (C, and it the user may add any additional sample, reagent, biological sample or the like which may need to be stored at a lower temperature. Further, it is contemplated that the tile may be stored from temperature comprised between about −80° C. to about +50° C., or any temperature necessary to preserve the sample, reagent, biological sample or the like pre-loaded within the tile sealed by the use of a film layer. The use of the film layer covering the input and output ports is done routinely in drugs discovery when using standard micro-plates between the operation of loading reagents and the actual assay. The film layer prevents contamination and minute quantities of fluid from evaporating, with the consequence of changing their concentration and therefore modifying the assay or process conditions.

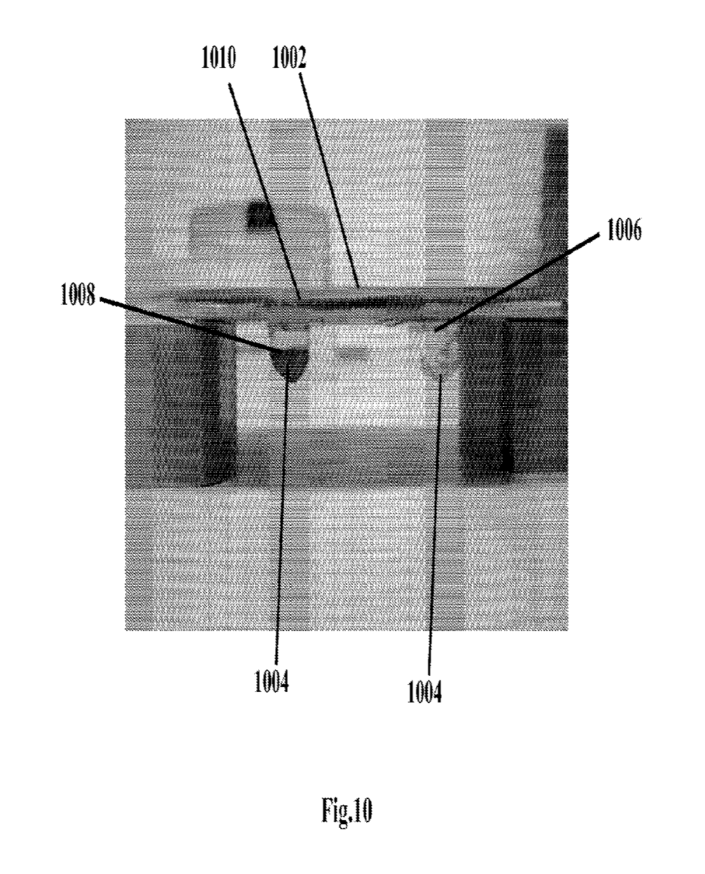

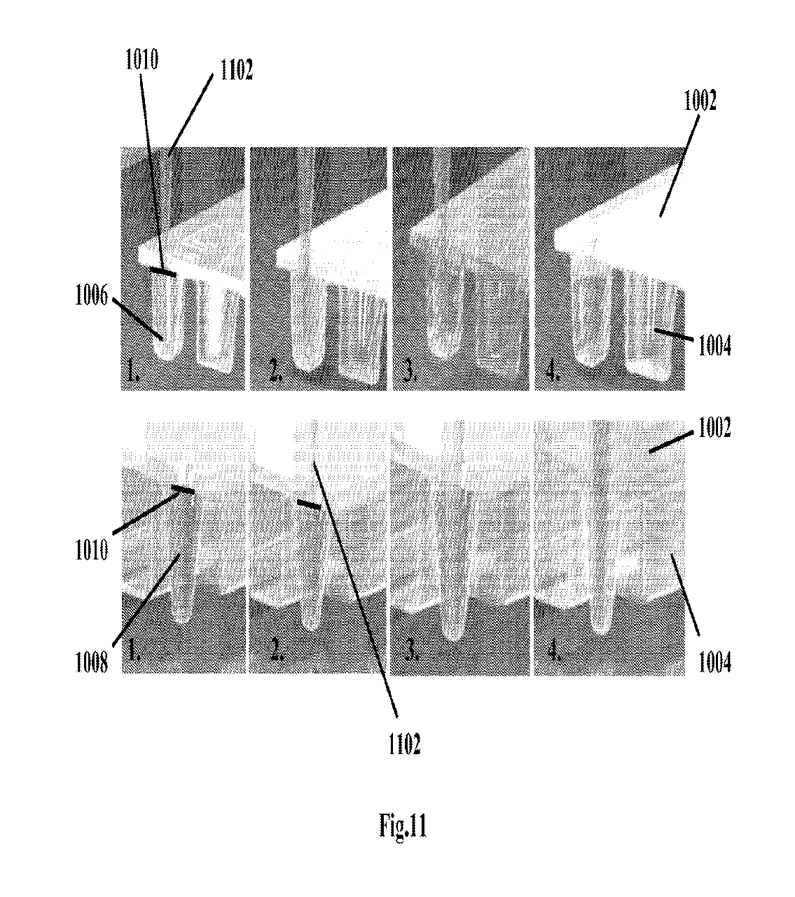

Referring to FIGS. 10 and 11, in one embodiment the tile may include a microfluidic substrate 1002, a macrofluidic substrate 1004, input ports 1006, and output ports 1008. In this embodiment the input ports 1006 and the output ports 1008 may be sealed by a film layer 1010. The purpose of the film layer 1010 may be to seal the input ports 1006 and the output ports 1008 to prevent any contaminants from entering the input ports 1006 and the output ports 1008 prior to use. For example, the film layer 1010 may prevent the input ports 1006 and the output ports 1008 from being contaminated with RNase or DNase. To input or extract a sample, reagent, biological sample, or the like a user may perforate or pierce the film layer 1010 and insert a fluid handling device 1102, such as but not limited to a pipette, into the input ports 1006 and/or the output ports 1008.

It is contemplated within the scope of the disclosure that the film layer may be the same film layer that may be placed between the microfluidic and microfluidic substrates of the tile. Further, the film layer can be fabricated from polymeric material, natural rubber, or any material having the feature of being inert to liquids used and pierceable for the introduction of liquids, while maintaining gas tightness afterwards to prevent evaporation of store reagents. It is further contemplated within the scope of the disclosure that the film layer can be obtained by application of a laminated film containing metallic and polymeric layers. The metallic layer allows a low permeability to gas and liquids, and the polymeric layer allows for an easy and effective sealing of the store reagents within the tile. It is also contemplated within the scope of the disclosure to have a combination of two film layers, one of which could coincide with the film layer placed between the microfluidic and the macrofluidic substrate. This double film configuration allows for an improved resistance to possible contamination from nucleic acids or enzymes like RNases and DNases since one of the films will prevent the other film from being contaminated towards the outside, diminishing the probability of transporting undesired molecules during the operation of sample or reagent loading or unloading in an unprotected environment.

It is further contemplated within the scope of the disclosure that the tile may have a plurality of input and output ports. The input and output ports may have a length inside the tile that can be decided arbitrarily accordingly to the fluid volumes to be loaded or extracted and the pitch between successive input and output ports can be chosen accordingly to existing standards and specific integration needs. Nominal pitch values of 2.25 mm, 4 5 mm or 9 mm correspond to the 1536, 384 and 96 wells micro-titre plate standards respectively.

The number of input and output ports per tile, the number of tiles, and the orientation of the tiles can be changed to achieve various configurations having a standard laboratory format or interface or a custom format. The various configurations are dependent on the tile design and on the application and strategy to input or collect samples, reagents, biological samples, and the like. The number of input ports and output ports on the tile can be made without requiring changes to the fluid handling device.

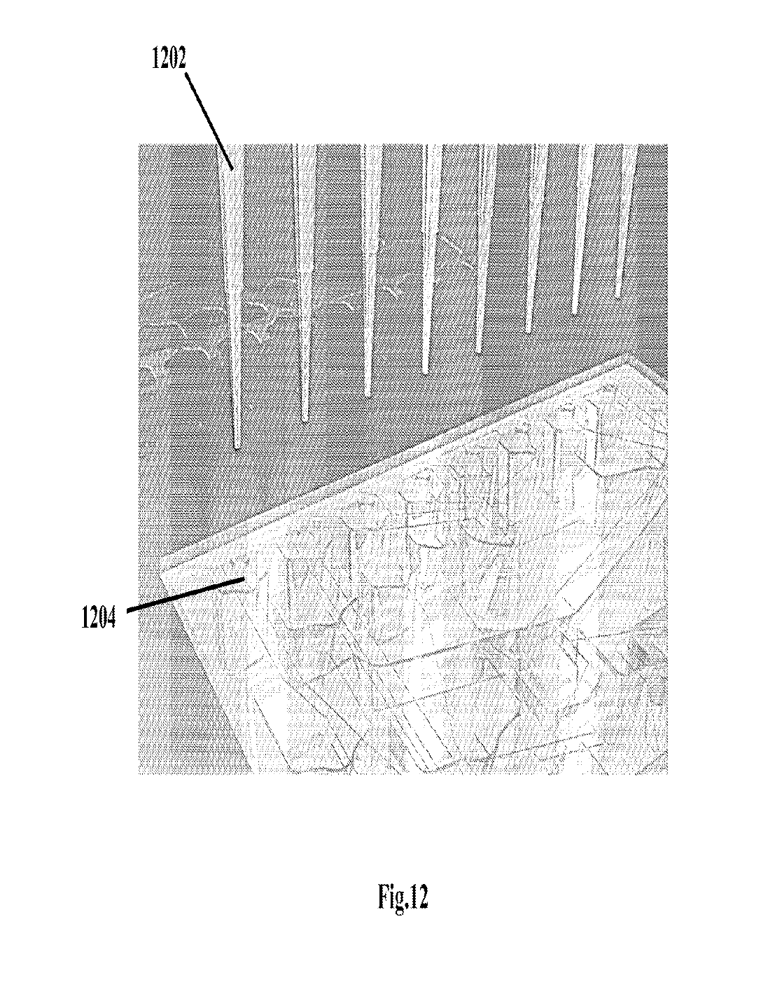

Turning to FIG. 12, in one embodiment the loading operation of a tile with a parallel dispenser is depicted. The parallel dispenser has 8 heads 1202 and performs the loading. In this illustrative embodiment, the heads 1202 allows the dispensing of a reagent, sample, biological sample, or other selected fluid into the input ports 1204 of the tile. Since many assays and processes consists in the repetition of a protocol to test different targets or different chemical entities in parallel, a fraction of the reagents, samples, biological samples, or other selected fluids of the assay or process may be in common, and a fraction of the reagents, samples, biological samples, or other selected fluids may be varied.

These tiles could be processed in a variety of systems, including among other centripetal systems. The application of centrifugation allows for liquid transfers when enabled by suitable valves, that could be pre-programmed, actuated at rest, or actuated during rotation.

In another embodiment, it is contemplated within the scope of the disclosure that the tiles may be processed individually or in groups, according to the throughput needs. In this embodiment the tiles may be processed through the use of a centripetal system. It is contemplated that the centripetal system may be operated in some applications at about 4° C. or at a predefined temperature. In this embodiment six tiles may be loaded into a rotor within the centripetal system. The rotor may be driven by an asynchronous brushless motor having a torque of about 2.1 Nm and a maximum speed of about 4500 rpm. However, it is contemplated within the scope of the disclosure that any number of tiles may be loaded into any centripetal system known in the art. For liquid volumes conventionally used in the current laboratory practice, the rotation speed of the system is preferentially chosen between about 50 and about 1500 rpm, independently of the number of tiles present on the rotor, which are sufficient in a Benchtop system to overcome the effect of gravity and induce motion of the liquid mass without the need of applying an excessive force onto the tiles. It is further contemplated within the scope of the disclosure that it is not required to position the tiles at a constant distance from the rotation axis, and that the tiles can be loaded in multiple rows in order to save space. According to the disclosure, it is preferable to have the input ports facing or closest to the rotation axis. This positioning is desirable since fluids subject to the centripetal acceleration will tend to move radially towards the outer part of the rotor and the input ports can be optimally designed for fluid collection. In this embodiment, the tiles can be processed on a centripetal platform, that spins in order to position the valve actuator in the correct position, and can move the fluids inside the tiles bycentrifugation.

The principles, preferred embodiments and modes of operation of the presently disclosed have been described in the foregoing specification. The presently disclosed however, is not to be construed as limited to the particular embodiments shown, as these embodiments are regarded as illustrious rather than restrictive. Moreover, variations and changes may be made by those skilled in the art without departing from the spirit and scope of the instant disclosure and disclosed herein and recited in the appended claims.

What is claimed is:

1. An apparatus for processing fluids comprising:
a first substrate comprising at least one microfluidic structure; and
a second substrate comprising at least one macrofluidic structure, said at least one macrofluidic structure corresponding to said at least one microfluidic structure in said first substrate.
